(19) United States
(12) Patent Application Publication
(10) Pub. No.: US 2016/0197738 A1
(43) Pub. Date: Jul. 7, 2016

(54) CONNECTION MANAGEMENT APPARATUS, COMMUNICATION MANAGEMENT SYSTEM, COMMUNICATION SYSTEM, COMPUTER PROGRAM, AND METHOD FOR CONTROLLING CONNECTION

(71) Applicant: Naoki UMEHARA, Kanagawa (JP)

(72) Inventor: Naoki UMEHARA, Kanagawa (JP)

(21) Appl. No.: 15/068,840

(22) Filed: Mar. 14, 2016

Related U.S. Application Data
(63) Continuation of application No. PCT/JP2014/076637, filed on Sep. 29, 2014.

(30) Foreign Application Priority Data
Sep. 30, 2013 (JP) 2013-205319
Jul. 25, 2014 (JP) 2014-151881

(51) Int. Cl. H04L 12/18; H04L 29/12

(52) U.S. Cl. CPC H04L 12/18; H04L 61/2589

(57) ABSTRACT

A connection management apparatus includes a connection information management unit and a transmitter. When a session for transmitting content data between communication terminals via a relaying apparatus is established based on control by a first controller, the connection information management unit manages relaying apparatus connection information used for connecting to the relaying apparatus that relays the content data transmitted between the communication terminals in the session. When control that is related to the session and includes connection to the relaying apparatus is performed by a second controller different from the first controller, the transmitter transmits the relaying apparatus connection information managed by the connection information management unit to the second controller.

### CROSS-REFERENCE TO RELATED APPLICATIONS

This application is a continuation of PCT international Application Ser. No. PCT/JP2014/076637, filed on Sep. 29, 2014, which designates the United States and which claims the benefit of priority from Japanese Patent Applications No. 2013-205319, filed on Sep. 30, 2013, and No. 2014-151881, filed on Jul. 25, 2014; the entire contents of which are incorporated herein by reference.

### BACKGROUND OF THE INVENTION

1. Field of the Invention

The present invention relates to a management of information used for connecting to relaying apparatus when content data is transmitted between communication terminals via the relaying apparatus.

2. Description of the Related Art

Recently, teleconference systems used for performing teleconferences via communication networks such as the Internet have become widespread along with requests for reductions in business trip expenses and business trip times. In such a teleconference system, the transmission and reception of content data such as image data and voice data are performed via a relaying apparatus, thereby achieving a teleconference.

It is known that a teleconference management system is used in order to perform control to establish and disconnect sessions for transmitting and receiving content data between teleconference terminals via a relaying apparatus (refer to Patent Literature 1). The teleconference management system manages connection information used for connecting the teleconference terminals to the relaying apparatus relaying content data transmitted between the teleconference terminals and can connect and disconnect the teleconference terminals and the relaying apparatus based on the connection information. In this case, in order to perform control related to sessions, one teleconference system is assigned to each session.

However, in a session in which content data is transmitted between communication terminals via a relaying apparatus, when control including connection to the relaying apparatus is performed by one controller, a problem arises in that a load is imposed on the controller.

### SUMMARY OF THE INVENTION

It is an object of the present invention to at least partially solve the problems in the conventional technology.

According to an embodiment, a connection management apparatus includes a connection information management unit and a transmitter. When a session for transmitting content data between communication terminals via a relaying apparatus is established based on control by a first controller, the connection information management unit manages relaying apparatus connection information used for connecting to the relaying apparatus that relays the content data transmitted between the communication terminals in the session. When control that is related to the session and includes connection to the relaying apparatus is performed by a second controller different from the first controller, the transmitter transmits the relaying apparatus connection information managed by the connection information management unit to the second controller.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram of a communication system according to an embodiment of the present invention;

FIG. 2 is a conceptual diagram illustrating the state of the transmission and reception of image data, voice data, and various management information in the communication system;

FIG. 3 is an external view of a terminal according to the embodiment of the present invention;

FIG. 4 is a hardware configuration diagram of the terminal according to the embodiment of the present invention;

FIG. 5 is a hardware configuration diagram of a management system according to the embodiment of the present invention;

FIG. 6 is a functional block diagram of a terminal, apparatuses, and a system constituting the communication system according to the embodiment;

FIG. 7 is a conceptual diagram illustrating a destination list;

FIGS. 8A and 8B are conceptual diagrams illustrating relaying apparatus management tables;

FIGS. 9A and 9B are conceptual diagrams illustrating terminal authentication management tables;

FIGS. 10A and 10B are conceptual diagrams illustrating state management tables;

FIGS. 11A and 11B are conceptual diagrams illustrating destination list management tables;

FIGS. 12A and 12B are conceptual diagrams illustrating session management tables;

FIGS. 13A and 13B are conceptual diagrams illustrating state change management tables;

FIG. 14 is a conceptual diagram illustrating a relaying apparatus selection management table;

FIGS. 15A and 15B are conceptual diagrams illustrating terminal management tables;

FIG. 16 is a conceptual diagram illustrating the state of the transmission and reception of various information in the communication system;

FIG. 17 is a sequence diagram illustrating procedure of inter-node cooperation;

FIG. 18 is a sequence diagram illustrating procedure of a preparatory stage for starting communication between terminals;

FIG. 19 is a sequence diagram illustrating procedure of making the operation states of terminals coincide between controllers;

FIG. 20 is a sequence diagram illustrating procedure to select a relaying apparatus;

FIG. 21 is a flow diagram illustrating procedure to select a relaying apparatus;

FIG. 22 is a sequence diagram illustrating procedure to request the start of communication;

FIG. 23 is a state transition diagram illustrating transitions between states of a terminal;

FIG. 24 is a flow diagram illustrating procedure to change the state of a terminal;

FIG. 25 is a sequence diagram illustrating procedure to start communication between terminals;

FIG. 26 is a sequence diagram illustrating procedure to start communication among three terminals;

FIG. 27 is a sequence diagram illustrating procedure to end communication; and

FIG. 28 is a conceptual diagram illustrating a destination list of another embodiment.

### DETAILED DESCRIPTION OF THE PREFERRED EMBODIMENTS

Overall Structure of Embodiment

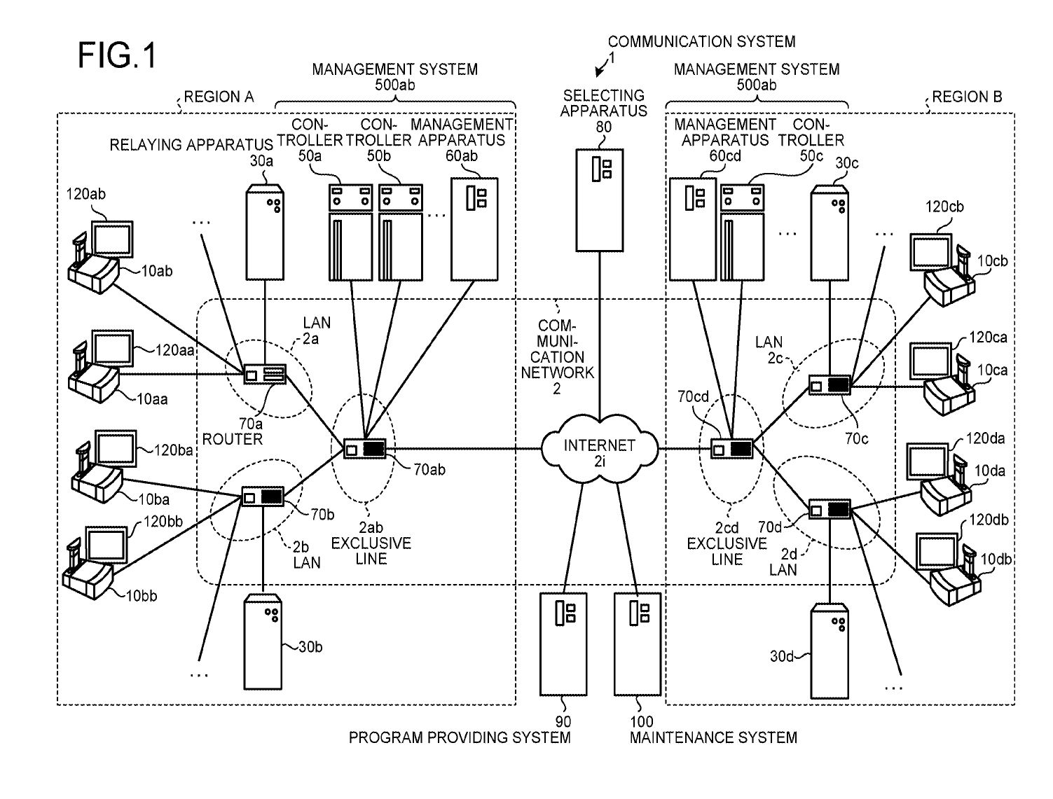

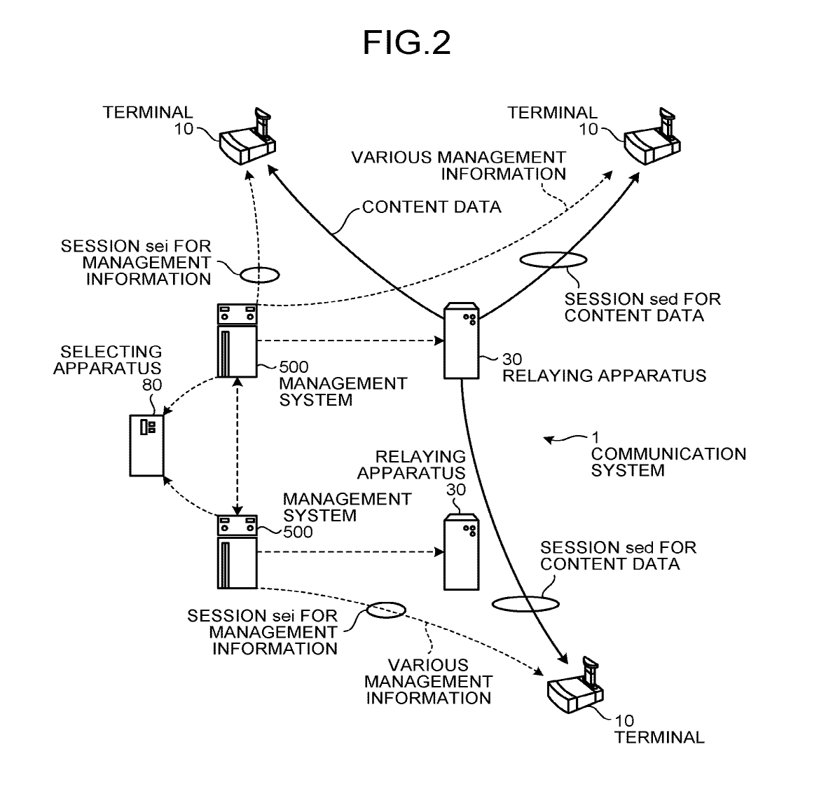

An embodiment according to the present invention will be described below. First, the overall structure of the embodiment will be described with reference to FIG. 1 and FIG. 2. FIG. 1 is a schematic diagram of a communication system according to the embodiment of the present invention. FIG. 2 is a conceptual diagram illustrating the state of the transmission and reception of image data, voice data, and various management information in the communication system.

The communication system according to the present embodiment includes a data providing system that communicates content data unidirectionally from one communication terminal to another communication terminal and a communication system that transmits information mutually among a plurality of communication terminals. This communication system is a system for transmitting information mutually among a plurality of communication terminals (corresponding to “communication terminals”) via a communication management system (corresponding to a “communication management system”), and examples thereof may include teleconference systems, videophone systems, voice conference systems, voice phone systems, personal computer (PC) screen sharing systems, and data sharing systems.

The present embodiment describes a communication system, a communication management system, and a communication terminal assuming a teleconference system as an example of the communication system, a teleconference management system as an example of the communication management system, and a teleconference terminal as an example of the communication terminal. In other words, the communication terminal and the communication management system according to the present embodiment are not only used in the teleconference system, but also used in the communication system.

This communication system 1 illustrated in FIG. 1 includes a plurality of communication terminals (10aa, 10ab, . . . ), displays (120aa, 120ab, . . . ) for the respective communication terminals (10aa, 10ab, . . . ), a plurality of relaying apparatuses (30a, 30b, 30c, 30d), a plurality of communication management systems (500ab, 500cd), a relaying apparatus selecting apparatus 80, a program providing system 90, and a maintenance system 100. The communication terminals 10 perform communication through the transmission and reception of image data and voice data as examples of content data. The content data is not limited to the image data and the voice data and may be at least one of image data, voice data, and text data, for example. The image of the image data may be a moving image and a still image and may be both a moving image and a still image. The present embodiment describes a case in which the image of the image data is a moving image.

In the following, the “communication terminal” will be simply denoted as a “terminal,” the “communication management system” will be simply denoted as a “management system,” and the “relaying apparatus selecting apparatus” will be simply denoted as a “selecting apparatus.” Among the communication management systems (500ab, 500cd), any management system will be denoted as a “management system 500.” Among the terminals (10aa, 10ab, . . . ), any terminal will be denoted as a “terminal 10.” Among the displays (120aa, 120ab, . . . ), any display will be denoted as a “display 120.” Among the relaying apparatuses (30a, 30b, 30c, 30d), any relaying apparatus will be denoted as a “relaying apparatus 30.”

As illustrated in FIG. 2, in the communication system 1, a session sei for management information is established for transmitting and receiving various management information between the terminals 10 via the management system 500. A session is established for transmitting and receiving image data and voice data between the terminals 10 via the relaying apparatus 30. In this example, the session for transmitting and receiving the image data and the voice data is collectively illustrated as a session sed for content data.

The terminal 10 illustrated in FIG. 1 performs the transmission and reception of content data such as image data and voice data in order to perform communication with the other terminal 10. In other words, the communication in the present embodiment includes not only the transmission and reception of the voice data, but also the transmission and reception of the image data. The terminal 10 may perform the transmission and reception of the voice data without performing the transmission and reception of the image data. The relaying apparatus 30 selected out of the relaying apparatuses 30 by the selecting apparatus 80 relays content data among the terminals 10. The management system 500 may be constructed by a plurality of computers. In the communication system 1 illustrated in FIG. 1, a plurality of controllers (50a, 50b, . . . ) and a management apparatus 60ab construct the communication management system 500ab. In the following, among the controllers (50a, 50b, . . . ), any controller will be denoted as a “controller 50.”

A plurality of routers (70a, 70b, 70c, 70d, 70ab, 70cd) select an optimum path of content data. In the following, among the routers (70a, 70b, 70c, 70d, 70ab, 70cd), any router will be denoted as a “router 70.”

The program providing system 90 includes a hard disk (HD) 204 described below, which stores therein a program for terminals to cause the terminal 10 to implement various functions (or to cause the terminal 10 to function as various units) and can transmit the program for terminals to the terminal 10. The HD 204 of the program providing system 90 also stores therein a program for relaying apparatuses to cause the relaying apparatus 30 to implement various functions (or to cause the relaying apparatus 30 to function as various units) and can transmit the program for relaying apparatuses to the relaying apparatus 30. The HD 204 of the program providing system 90 also stores therein a program for a selecting apparatus to cause the selecting apparatus 80 to implement various functions (or to cause the selecting apparatus 80 to function as various units) and can transmit the program for a selecting apparatus to the selecting apparatus 80. The HD 204 of the program providing system 90 also stores therein a program for a maintenance system to cause the maintenance system 100 to implement various functions (or to cause the maintenance system 100 to function as various units) and can transmit the program for a maintenance system to the maintenance system 100.

The maintenance system 100 is a computer for keeping, managing, or maintaining at least one of the terminal 10, the relaying apparatus 30, the management system 500, the selecting apparatus 80, and the program providing system 90. When the maintenance system 100 is domestically installed, and the terminal 10, the relaying apparatus 30, the management system 500, the selecting apparatus 80, and the program providing system 90 are installed abroad, for example, the maintenance system 100 keeps, manages, or maintains at least one of the terminal 10, the relaying apparatus 30, the management system 500, the selecting apparatus 80, and the program providing system 90 remotely via a communication network 2. The maintenance system 100 performs maintenance such as the management of the model number, serial number, customer, maintenance and inspection, trouble history or the like of at least one of the terminal 10, the relaying apparatus 30, the management system 500, the selecting apparatus 80, and the program providing system 90 without the involvement of the communication network 2.

The terminals (10aa, 10ab, . . . ), the relaying apparatus 30a, and the router 70a are communicably connected via a LAN 2a. The terminals (10ba, 10bb, . . . ), the relaying apparatus 30b, and the router 70b are communicably connected via a LAN 2b. The management system 500ab, the LAN 2a, and the LAN 2b are communicably connected via an exclusive line 2ab including the router 70ab and are constructed in a given region A. The region A is Japan, the LAN 2a is constructed in a Tokyo office, and the LAN 2b is constructed in an Osaka office, for example. The management system 500ab manages the state of the terminals (10aa, 10ab, . . . 10ba, 10bb, . . . ) connected to the LAN 2a or the LAN 2b and controls the connection between the terminals 10 using the relaying apparatuses (30a, 30b).

The terminals (10ca, 10bb, . . . ), the relaying apparatus 30c, and the router 70c are communicably connected via a LAN 2c. The terminals (10da, 10db, . . . ), the relaying apparatus 30d, and the router 70d are communicably connected via a LAN 2d. The management system 500cd, the LAN 2c, and the LAN 2d are communicably connected via an exclusive line 2cd including the router 70cd and are constructed in a given region B. The region B is the United States of America, the LAN 2c is constructed in a New York office, and the LAN 2d is constructed in a Washington D.C. office, for example. The region A and the region B are communicably connected via the Internet 2i from the routers (70ab, 70cd), respectively. The management system 500cd manages the state of the terminals (10ca, 10db, . . . ) connected to the LAN 2c or the LAN 2d and controls the connection among the terminals 10 using the relaying apparatuses (30c, 30d).

The selecting apparatus 80, the program providing system 90, and the maintenance system 100 are communicably connected with the terminal 10, the relaying apparatus 30, or the management system 500 via the Internet 2i. The selecting apparatus 80, the program providing system 90, and the maintenance system 100 may be installed in the region A or the region B or may be installed in any region other than these regions.

In the present embodiment, the communication network 2 according to the present embodiment is constructed by the LAN 2a, the LAN 2b, the exclusive line tab, the Internet 2i, the exclusive line 2cd, the LAN 2c, and the LAN 2d. The communication network 2 may include a part in which, not only wired, but also wireless communication such as Wireless Fidelity (WiFi) and Bluetooth (registered trademark) is performed.

The terminals 10 may be used in, not only communication between a plurality of offices and communication between different rooms in the same office, but also communication within the same room and outdoor-to-indoor or outdoor-to-outdoor communication. When the terminals 10 are used outdoor, wireless communication such as mobile phone communication network is performed.

Hardware Configuration of Embodiment

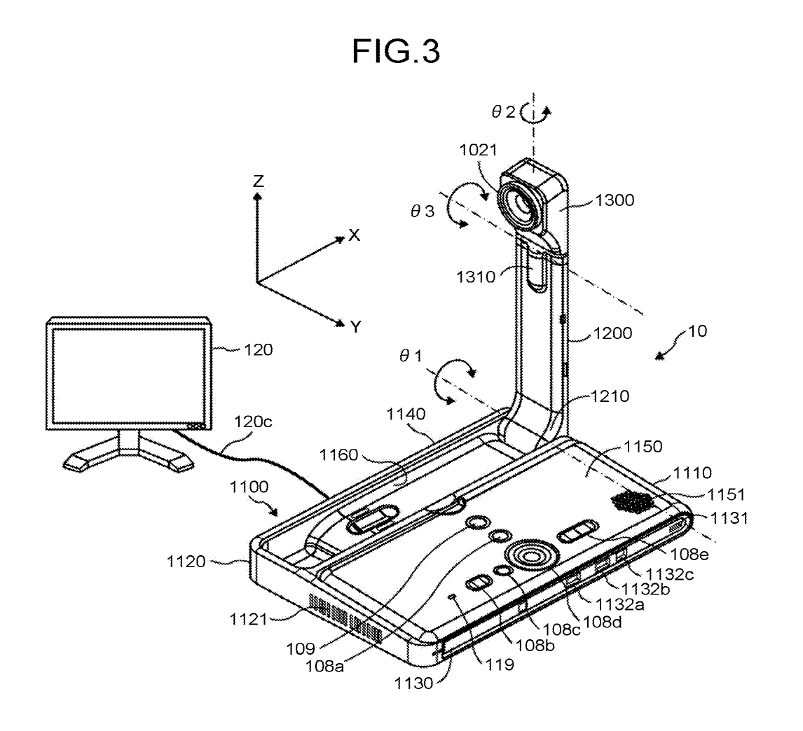

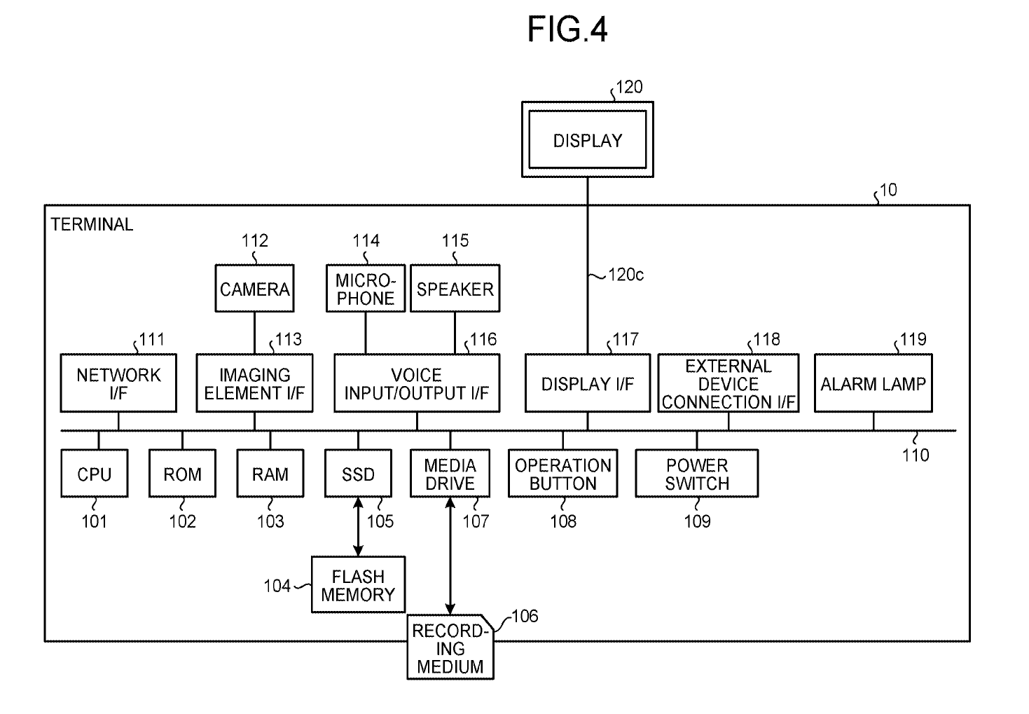

Next, the hardware configuration of the present embodiment will be described. First, the hardware configuration of the terminal 10 will be described with reference to FIG. 3 and FIG. 4. FIG. 3 is an external view of a terminal according to the embodiment of the present invention. FIG. 4 is a hardware configuration diagram of the terminal according to the embodiment of the present invention. The following will describe with the longitudinal direction of the terminal 10 as an X-axial direction, with the direction orthogonal to the X-axial direction on the horizontal plane as a Y-axial direction, and with the direction (the vertical direction) orthogonal to the X-axial direction and the Y-axial direction as a Z-axial direction.

As illustrated in FIG. 3, the terminal 10 includes a housing 1100, an arm 1200, and a camera housing 1300. An intake plane (not illustrated) formed by a plurality of intake holes is formed on a front wall 1110 of the housing 1100, whereas an exhaust plane 1121 formed by a plurality of exhaust holes is formed on a rear wall 1120 of the housing 1100. This takes in outside air in the rear of the terminal 10 via the intake plane (not illustrated) and exhausts it to the rear of the terminal 10 via the exhaust plane 1121 by the drive of a cooling fan incorporated in the housing 1100. A sound pickup hole 1131 is formed on a right wall 1130 of the housing 1100, and sounds such as voices, sounds, and noises can be picked up by a built-in microphone 114 described below.

An operating panel 1150 is formed on the right wall 1130 of the housing 1100. The operating panel 1150 includes a plurality of operation buttons (108a to 108e) described below, a power switch 109 described below, an alarm lamp 119 described below, and a sound output plane 1151 formed by a plurality of sound output holes for passing through output sounds from a built-in speaker 115 described below. A housing unit 1160 as a recess for housing the arm 1200 and the camera housing 1300 is formed on a left wall 1140 of the housing 1100. A plurality of connecting ports (1132a to 1132c) are formed on the right wall 1130 of the housing 1100 for electrically connecting cables to an external device connection I/F 118 described below. A connecting port (not illustrated) is formed on the left wall 1140 of the housing 1100 for electrically connecting a cable 120c for the display 120 to the external device connection I/F 118 described below.

In the following description, an “operation button 108” will be used when indicating any operation button among the operation buttons (108a to 108e), and a “connecting port 1132” will be used when indicating any connecting port among the connecting ports (1132a to 1132c).

The arm 1200 is attached to the housing 1100 via a torque hinge 1210, and the arm 1200 is rotatable in the up and down direction within the range of a tilt angle θ1 of 135 degrees with respect to the housing 1100. FIG. 3 illustrates a state in which the tilt angle θ1 is 90 degrees.

The camera housing 1300 includes a built-in camera 112 described below, which can image users, documents, rooms, or the like. The camera housing 1300 forms a torque hinge 1310. The camera housing 1300 is attached to the arm 1200 via the torque hinge 1310. The camera housing 1300 is attached to the arm 1200 via the torque hinge 1310, and the camera housing 1300 is rotatable with respect to the arm 1200 in the up and down and right and left directions within the range of a pan angle θ2 of ±180 degrees and within the range of a tilt angle θ3 of ±45 degrees with the state illustrated in FIG. 3 as 0 degree.

As illustrated in FIG. 4, the terminal 10 according to the present embodiment includes a central processing unit (CPU) 101 that controls the entire operation of the terminal 10, a read only memory (ROM) 102 that stores therein the program for terminals, a random access memory (RAM) 103 used as a work area of the CPU 101, a flash memory 104 that stores therein various data such as image data and voice data, a solid state drive (SSD) 105 that controls the reading and writing of the various data from and into the flash memory 104 in accordance with the control of the CPU 101, a media drive 107 that controls the reading and writing (recording) data from and into a recording medium 106 such as a flash memory, the operation button 108 used when selecting a destination of the terminal 10 or the like, the power switch 109 for switching ON/OFF of the power of the terminal 10, and a network interface (I/F) 111 for performing data communication using the communication network 2 described below.

The terminal 10 also includes the built-in camera 112 that images a subject in accordance with the control of the CPU 101 and obtains image data, an imaging element I/F 113 that controls the drive of the camera 112, the built-in microphone 114 that inputs voices, the built-in speaker 115 that outputs voices, an voice input/output I/F 116 that processes the input and output of voice signals between the microphone 114 and the speaker 115 in accordance with the control of the CPU 101, a display I/F 117 that communicates image data to the external display 120 in accordance with the control of the CPU 101, an external device connection I/F 118 for connecting various external devices, the alarm lamp 119 indicating abnormalities of the various functions of the terminal 10, and a bus line 110 such as an address bus and a data bus for electrically connecting the above components as illustrated in FIG. 4.

The display 120 is a display unit including liquid crystals or organic EL displaying images of subjects, operating icons, or the like. The display 120 is connected to the display I/F 117 via the cable 120c. The cable 120c may be an analog RGB (VGA) signal cable, may be a component video cable, and may be a High-Definition Multimedia Interface (HDMI) or Digital Video Interactive (DVI) signal cable.

The camera 112 includes a lens and a solid-state imaging element that converts light into electric charges to digitize an image (video) of a subject, the solid-state imaging element being a complementary metal oxide semiconductor (CMOS), a charge coupled device (CCD), or the like.

External devices such as an external camera, an external microphone, and an external speaker can be electrically connected to the external device connection I/F 118 with a universal serial bus (USB) cable or the like inserted into the connecting port 1132 of the housing 1100 illustrated in FIG. 3. When the external camera is connected, the external camera is driven preferentially to the built-in camera 112 in accordance with the control of the CPU 101. Similarly, when the external microphone is connected, or when the external speaker is connected, the external microphone and the external speaker are driven preferentially to the built-in microphone 114 and the built-in speaker 115, respectively, in accordance with the control of the CPU 101.

The recording medium 106 is attachable and detachable to and from the terminal 10. It is only required to be a nonvolatile memory that reads and writes data in accordance with the control of the CPU 101. Without being limited to the flash memory 104, it may be an electrically erasable and programmable ROM (EEPROM) or the like.

The program for terminals may be recorded in a computer-readable recording medium (the recording medium 106 or the like) as an installable or executable file and distributed. The program for terminals may be stored in the ROM 102 rather than the flash memory 104. The external view and the hardware configuration diagram illustrated in FIG. 3 and FIG. 4 are merely an embodiment and are not limiting. The appearance and hardware may be, for example, a general desktop or notebook personal computer, a smartphone, a tablet type terminal, an electronic blackboard, a projecting apparatus such as a projector, an image forming apparatus such as a multifunction peripheral and a printer, a wearable terminal, and a network-connectable industrial apparatus. In this case, a camera and a microphone are not necessarily required to be built in and may be externally attached.

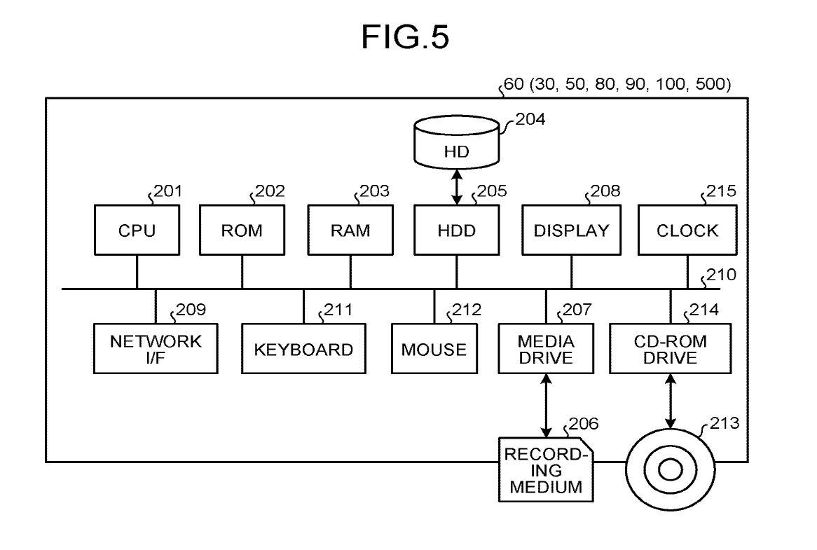

The following describes the hardware configuration of the controller 50, a management apparatus 60, the relaying apparatus 30, the selecting apparatus 80, the program providing system 90, the maintenance system 100, and the management system 500 with reference to FIG. 5. FIG. 5 is a hardware configuration diagram of a controller according to the embodiment of the present invention. The relaying apparatus 30, the management apparatus 60, the selecting apparatus 80, the program providing system 90, and the maintenance system 100 have the same appearance as a general server computer, and the description of their appearance is omitted.

The management apparatus 60 includes a CPU 201 that controls the entire operation of the management apparatus 60, a ROM 202 that stores therein a program for use in the drive of the CPU 201 such as an initial program loader (IPL), a RAM 203 used as a work area of the CPU 201, an HD 204 that stores therein various data such as a program for communication management, a hard disk drive (HDD) 205 that controls the reading and writing of the various data from and into the HD 204 in accordance with the control of the CPU 201, a media drive 207 that controls the reading and writing (recording) of data from and into a recording medium 206 such as a flash memory, a display 208 that displays various information such as cursors, menus, windows, characters, and images, a network I/F 209 for performing data communication using the communication network 2, a keyboard 211 having a plurality of keys for inputting characters, numeric values, various instructions, and the like, a mouse 212 that performs the selection and execution of various instructions, the selection of an object to be processed, the movement of a cursor, and the like, a CD-ROM drive 214 that controls the reading and writing of various data from and into a compact disc read only memory (CD-ROM) 213 as an example of a detachable recording medium, a clock 215 as an internal clock of the management apparatus 60, and a bus line 210 such as an address bus and a data bus for electrically connecting the above components as illustrated in FIG. 5.

The program for communication management may be recorded in a computer-readable recording medium such as the recording medium 206 and the CD-ROM 213 as an installable or executable file and distributed. The program for communication management may be stored in the ROM 202 rather than the HD 204.

The relaying apparatus 30, the controller 50, the selecting apparatus 80, the program providing system 90, the maintenance system 100 have the same hardware configuration as the management apparatus 60, and the detailed description thereof is omitted. The HD 204 records therein the program for relaying apparatuses, the program for communication control, the program for a selecting apparatus, a program for program provision, or a program for maintenance for controlling the relaying apparatus 30, the selecting apparatus 80, the program providing system 90, or the maintenance system 100. Also in this case, the programs may be recorded in a computer-readable recording medium such as the recording medium 206 and the CD-ROM 213 as an installable or executable file and distributed. The programs may be stored in the ROM 202 rather than the HD 204. The programs may be recorded in a computer-readable recording medium such as a compact disc recordable (CD-R) and a digital versatile disc (DVD), which are other examples of the detachable recording medium and provided.

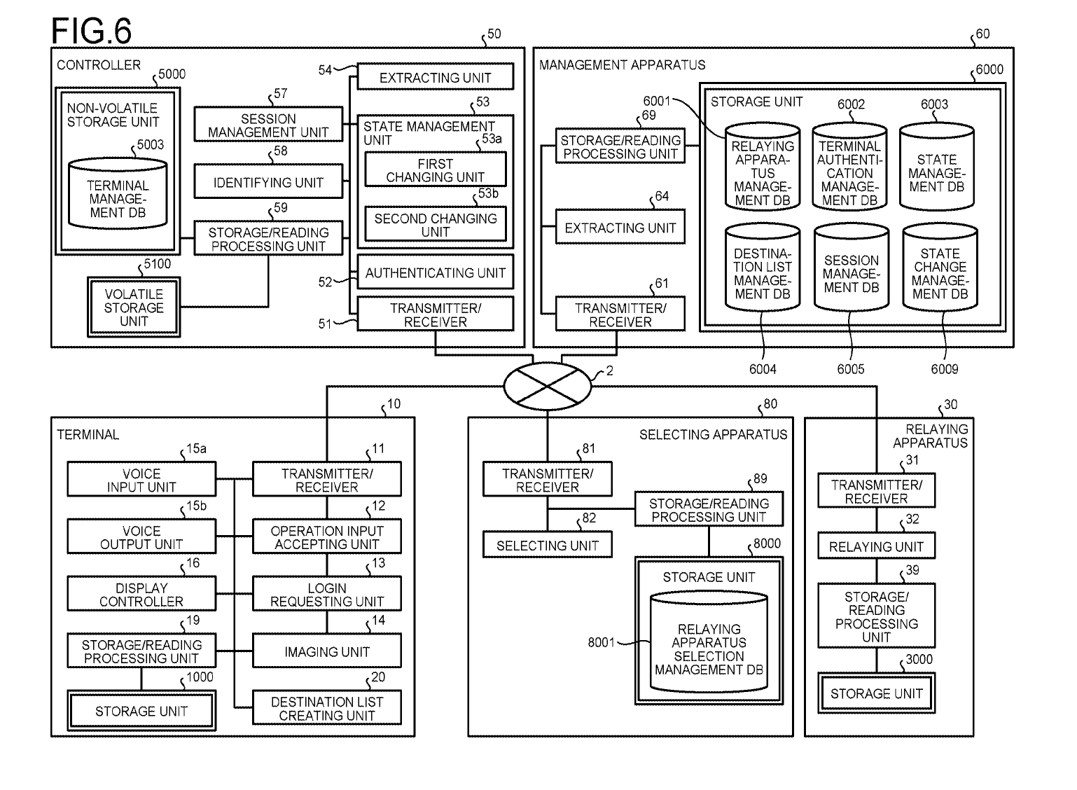

Functional Configuration of Embodiment Next, the functional configuration of the present embodiment will be described with reference to FIG. 6. FIG. 6 is a functional block diagram of a terminal, apparatuses, and a system constituting the communication system according to the embodiment. In FIG. 6, the terminal 10, the relaying apparatus 30, and the management system 500 are connected so as to perform data communication via the communication network 2. The program providing system 90 and the maintenance system 100 illustrated in FIG. 1 are omitted in FIG. 6, because they are not directly related to communication in a teleconference.

Functional Configuration of Terminal

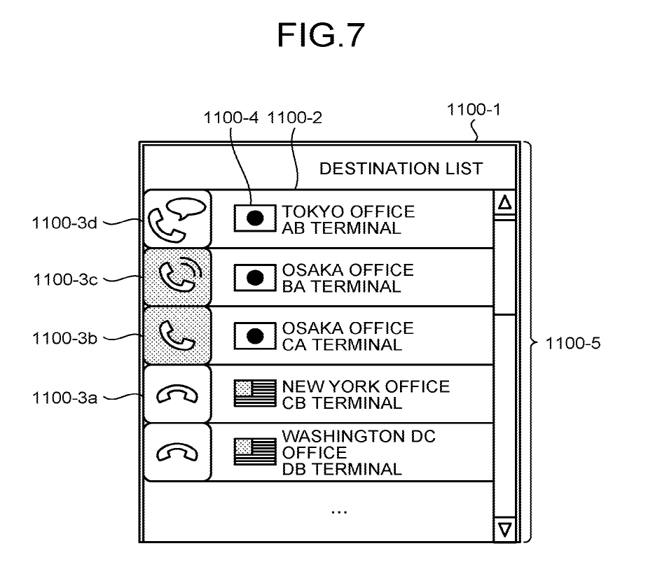

The terminal 10 includes a transmitter/receiver 11, an operation input accepting unit 12, a login requesting unit 13, an imaging unit 14, a voice input unit 15a, a voice output unit 15b, a display controller 16, a storage/reading processing unit 19, and a destination list creating unit 20. These components are functions or means that function implemented by the operation of any of the components illustrated in FIG. 4 by commands from the CPU 101 in accordance with the program for terminals loaded from the flash memory 104 onto the RAM 103. The terminal 10 includes a storage unit 1000 including the RAM 103 illustrated in FIG. 4 and the flash memory 104 illustrated in FIG. 4. The storage unit 1000 stores therein a destination list frame 1100-1 illustrated in FIG. 7. FIG. 7 is a conceptual diagram illustrating a destination list.

Functional Components of Terminal

Next, the functional configurations of the terminal 10 will be described with reference to FIG. 4 and FIG. 6. In describing the functional configurations of the terminal 10, the following will also describe the relation with principal components for achieving the functional configurations of the terminal 10 among the components illustrated in FIG. 4.

The transmitter/receiver 11 is implemented by commands from the CPU 101 illustrated in FIG. 4 and the network I/F 111 illustrated in FIG. 4 and performs the transmission and reception of various data (or information) with the other terminals, apparatuses, or systems via the communication network 2. The transmitter/receiver 11 starts the reception of respective pieces of state information indicating the states of the respective terminals 10 as destination candidates from the management system 500 before starting communication with the other terminal 10. This state information indicates the operation states (being online or offline, whether being in conference when being online, or the like) of the respective terminals 10. The state information indicates not only the operation states of the respective terminal 10, but also various states, in which the cable 120c is detached from the terminal 10, images are not output although voices are output, and voices are not output (mute) in the terminal 10. The following will describe a case in which the state information indicates the operation state, as an example.

The operation input accepting unit 12 is implemented by commands from the CPU 101 illustrated in FIG. 4 and the operation button 108 and the power switch 109 illustrated in FIG. 4 and receives various inputs from a user. When the user turns on the power switch 109 illustrated in FIG. 4, the operation input accepting unit 12 illustrated in FIG. 6 receives the power-on and turns on the power.

The login requesting unit 13 is implemented by commands from the CPU 101 illustrated in FIG. 4. With the acceptance of the power-on as a trigger, the login-requesting unit 13 automatically transmits login request information indicating a request for a login from the transmitter/receiver 11 to the management system 500 via the communication network 2. The trigger for transmitting the login request information is not limited to the power-on and may be the acceptance of operation input by the user via the operation input accepting unit 12. When the user turns off the power switch 109 from the power-on state, the transmitter/receiver 11 transmits state information indicating the turning off of the power to the management system 500, and then the operation input accepting unit 12 perfectly turns off the power. This causes the management system 500 to grasp that the terminal 10 has been turned from the power-on to power-off. In the present embodiment, the terminals (10aa, 10ab, . . . 10ba, 10bb, . . . ) on the LANs (2a, 2b) are connected to the management system 500ab, whereas the terminals (10ca, 10db, . . . ) on the LANs (2c, 2d) are connected to the management system 500cd.

The imaging unit 14 is implemented by commands from the CPU 101 illustrated in FIG. 4 and the camera 112 and the imaging element I/F 113 illustrated in FIG. 4, images a subject, and outputs image data obtained by the imaging.

The voice input unit 15a is implemented by commands from the CPU 101 illustrated in FIG. 4 and the voice input/output I/F 116 illustrated in FIG. 4, and after a voice of the user is converted into a voice signal by the microphone 114, inputs voice data related to the voice signal. The voice output unit 15b is implemented by commands from the CPU 101 illustrated in FIG. 4 and the voice input/output I/F 116 illustrated in FIG. 4, outputs a voice signal related to voice data to the speaker 115, and outputs a voice from the speaker 115.

The display controller 16 is implemented by commands from the CPU 101 illustrated in FIG. 4 and the display I/F 117 illustrated in FIG. 4 and performs control to transmit received image data to the display 120.

The display controller 16 causes the display 120 to display a destination list including destination names based on information received from the management system 500. The display controller 16 displays the destination list frame 1100-1 as illustrated in FIG. 7 on the display 120, for example. The destination list frame 1100-1 displays destination names such as a destination name “Tokyo Office AB terminal” 1100-2, icons (1100-3a, 1100-3b, 1100-3c, 1100-3d) indicating the state of the terminal 10 for each destination name, and an icon 1100-4 indicating a region. The icon 1100-3a indicates that the terminal 10 as one of the destination candidates is in an offline state (hereinafter, this state is called “Offline.”) and that it is incommunicable with this terminal. The icon 1100-3b indicates that the terminal 10 as one of the destination candidates is in a standby state before starting communication (hereinafter, this state is called “None.”) The icon 1100-3c indicates that the terminal 10 as one of the destination candidates is in a state requesting communication with the other terminal (hereinafter, this state is called “Calling.”) or a state being requested from the other terminal 10 (hereinafter, this state is called “Ringing.”). The icon 1100-3d indicates a state in which the above request is accepted (hereinafter, this state of the terminal 10 is called “Accepted.”) or a state in which the terminal 10 as one of the destination candidates is in communication with the other terminal 10 (hereinafter, this state is called “Busy.”) The destination list frame 1100-1 displays a scroll bar 1100-5 on the right, and upward and downward triangle icons are selected, thereby displaying destination names and state of destination candidates not illustrated in FIG. 7.

The storage/reading processing unit 19 is implemented by commands from the CPU 101 illustrated in FIG. 4 and the SSD 105 illustrated in FIG. 4 or implemented by commands from the CPU 101 and performs storing various data in the storage unit 1000 and reading the various data stored in the storage unit 1000. The storage unit 1000 stores therein terminal identifications (IDs) for identifying the terminal 10, passwords, and the like. The storage unit 1000 stores therein image data and voice data received each time communication with a destination terminal is performed in an overwriting manner for each reception. An image is displayed on the display 120 based on image date before being overwritten, and a voice is output from the speaker 115 based on voice data before being overwritten. The IDs such as the terminal IDs in the present embodiment indicate identification such as languages, characters, symbols, and various kinds of marks used for uniquely identifying the terminal 10, the user of the terminal 10, or the like. The IDs may be identification obtained by combining at least two of the languages, characters, symbols, and various kinds of marks.

The destination list creating unit 20 creates and updates a destination list indicating the states of the terminals 10 as destination candidates with icons as illustrated in FIG. 7 based on information received from the management system 500.

Functional Configuration of Relaying Apparatus

The relaying apparatus 30 includes a transmitter/receiver 31, a relaying unit 32, and a storage/reading processing unit 39. These components are functions or means that function implemented by the operation of any of the components illustrated in FIG. 5 by commands from the CPU 201 in accordance with the program for relaying apparatuses loaded from the HD 204 onto the RAM 203. The relaying apparatus 30 includes a storage unit 3000 including the RAM 203 illustrated in FIG. 5 or the HD 204 illustrated in FIG. 5.

Functional Components of Relaying Apparatus

Next, the functional components of the relaying apparatus 30 will be described in detail. In describing the functional configurations of the relaying apparatus 30, the following will also describe the relation with principal components for achieving the functional configurations of the relaying apparatus 30 among the components illustrated in FIG. 5.

The transmitter/receiver 31 of the relaying apparatus 30 illustrated in FIG. 6 is implemented by commands from the CPU 201 illustrated in FIG. 5 and the network I/F 209 illustrated in FIG. 5 and performs the transmission and reception of various data (or information) with the other terminals, apparatuses, or systems via the communication network 2. The relaying unit 32 is implemented by commands from the CPU 201 illustrated in FIG. 5 and relays content data transmitted and received among the terminals 10 in the session sed for content data via the transmitter/receiver 31. The storage/reading processing unit 39 is implemented by commands from the CPU 201 illustrated in FIG. 5 and the HDD 205 illustrated in FIG. 5 and performs storing various data in the storage unit 3000 and reading the various data stored in the storage unit 3000.

Functional Configuration of Management Apparatus

The management apparatus 60 includes a transmitter/receiver 61, an extracting unit 64, and a storage/reading processing unit 69. These components are functions or means that function implemented by the operation of any of the components illustrated in FIG. 5 by commands from the CPU 201 in accordance with the program for a management system loaded from the HD 204 onto the RAM 203. The management apparatus 60 includes a storage unit 6000 including the HD 204 illustrated in FIG. 5.

Relaying Apparatus Management Table

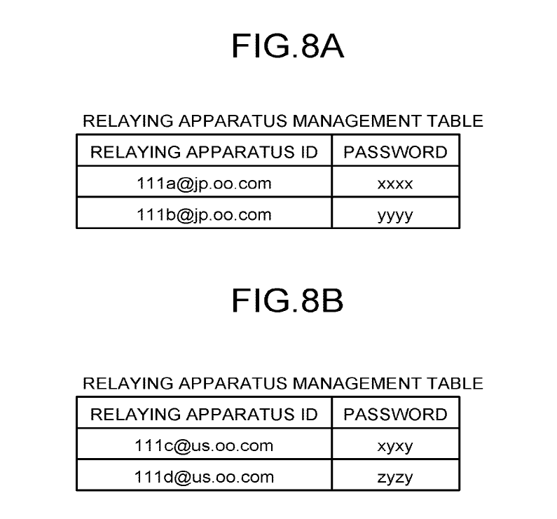

The storage unit 6000 includes a relaying apparatus management DB 6001 including a relaying apparatus management table as illustrated in FIGS. 8A and 8B. FIG. 8A is a conceptual diagram illustrating a relaying apparatus management table managed by the management apparatus 60ab, whereas FIG. 8B is a conceptual diagram illustrating a relaying apparatus management table managed by the management apparatus 60cd. The relaying apparatus management table manages relaying apparatus IDs of the respective relaying apparatuses 30 for which the control of connection can be performed by the management system 500 to which the corresponding management apparatus 60 belongs and passwords for connecting to the respective relaying apparatuses 30 in association with each other. The relaying apparatus management table illustrated in FIG. 8A, for example, indicates that the password for connecting to the relaying apparatus 30a identified by the relaying apparatus ID “111a@jp.oo.com” is “xxxx.” In the present embodiment, the relaying apparatus ID includes domain information (communication control information) such as “jp.oo.com” indicating the management system 500 that can perform control along with the start and end of communication using the relaying apparatus 30 identified thereby. When indicating the relaying apparatus ID in the following description, it will be simply denoted as “111a” or the like with the domain information such as “jp.oo.com” omitted, unless particularly specified. The following describes a case of using the relaying apparatus ID as information used for connecting to the relaying apparatus as an embodiment according to the present invention. However, any information used in the control of connection to the relaying apparatus 30 in the controller 50 is used as the information for connecting to the relaying apparatus without being limited to the relaying apparatus ID.

Terminal Authentication Management Table

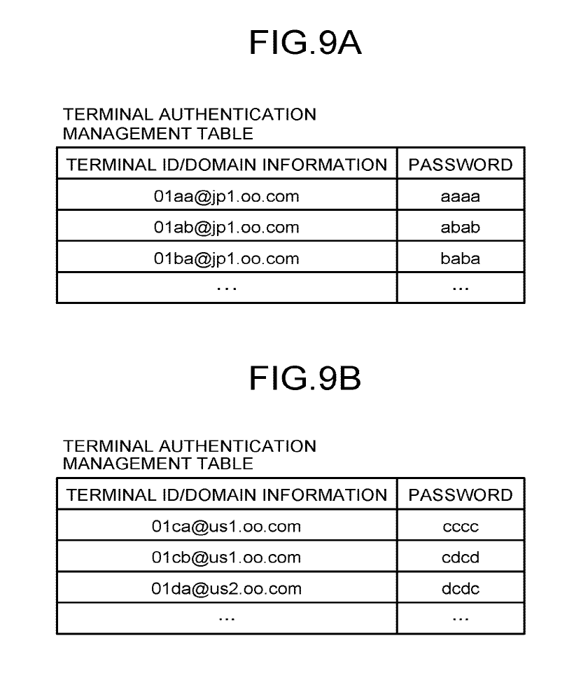

The storage unit 6000 further includes a terminal authentication management DB 6002 including a terminal authentication management table as illustrated in FIGS. 9A and 9B. FIG. 9A is a conceptual diagram illustrating a terminal authentication management table managed by the management apparatus 60ab, whereas FIG. 9B is a conceptual diagram illustrating a terminal authentication management table managed by the management apparatus 60cd. The terminal authentication management table manages respective terminal IDs of all terminals 10 connected to the management system 500 to which the corresponding management apparatus 60 belongs and respective passwords in association with each other. The terminal authentication management table illustrated in FIG. 9A, for example, indicates that the terminal ID of a terminal 10aa is “01aa@jp1.oo.com” and that the password is “aaaa.” In the present embodiment, the terminal ID includes domain information (terminal connection information) such as “jp1.oo.com” indicating the controller 50 to which the terminal 10 identified thereby connects. When indicating the terminal ID in the following description, it will be simply denoted as “01aa” or the like with the domain information such as “jp1.oo.com” omitted, unless particularly specified. The terminal ID indicated in this example is merely an example of information for use in authentication, and this table is only required to include at least identification for identifying the terminal 10 or the user of the terminal 10 and information for identifying the controller 50 to which the terminal 10 connects and is not limited to this form.

State Management Table

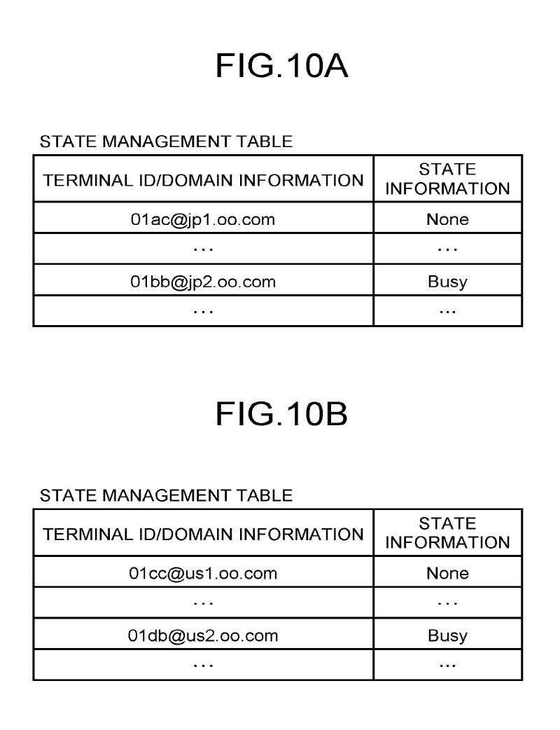

The storage unit 6000 includes a state management DB 6003 including a state management table as illustrated in FIGS. 10A and 10B. FIG. 10A is a conceptual diagram illustrating a state management table managed by the management apparatus 60ab, whereas FIG. 10B is a conceptual diagram illustrating a state management table managed by the management apparatus 60cd. The state management table manages the terminal IDs of the respective terminals 10 connecting to the respective controllers 50 within the management system 500ab and state information indicating the state of the communication of the terminal 10 in association with each other. In the present embodiment, the terminal ID includes domain information (terminal connection information) such as “jp1 (jp2).oo.com” indicating the controller 50a (50b) to which the terminal 10 identified thereby connects. This enables the state management table to manage the state of the terminal 10, for each controller 50, connecting to the controller 50.

The pieces of state information managed by the state management table are described. The state information “None” indicates a standby state before starting communication. The state information “Inviting” indicates a state in which the terminal 10 is requesting the start of communication with the other terminal. The state information “Invited” indicates a state in which the start of communication is being requested by the other terminal 10. The state information “Ringing” indicates a state in which the terminal 10 is outputting a dial tone. The state information “Calling” indicates a state in which the terminal 10 is outputting a ring tone. The information “Accepted” indicates a state in which a request to start communication is permitted. The information “Busy” indicates a state in which the terminal 10 is in communication with the other terminal 10.

Destination List Management Table

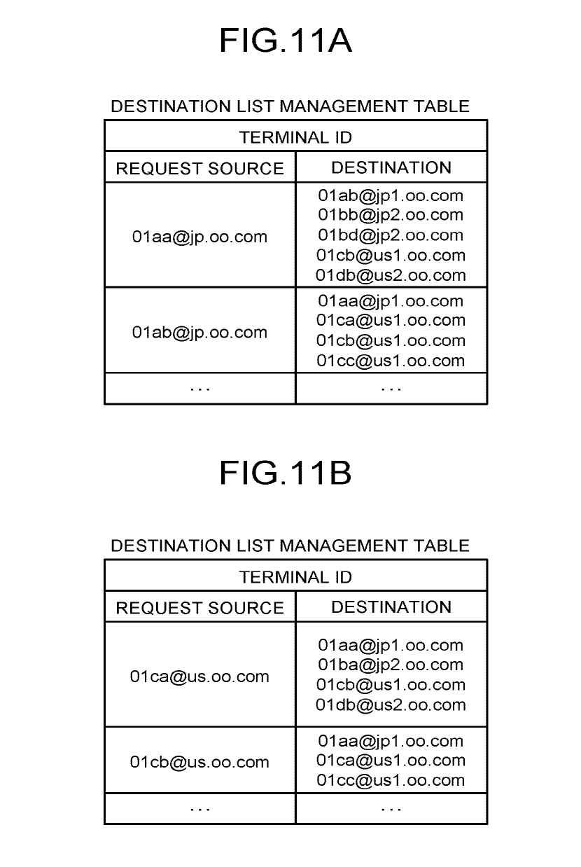

The storage unit 6000 includes a destination list management DB 6004 including a destination list management table as illustrated in FIGS. 11A and 11B. FIG. 11A is a conceptual diagram illustrating a destination list management table managed by the management apparatus 60ab, whereas FIG. 11B is a conceptual diagram illustrating a destination list management table managed by the management apparatus 60cd. The destination list management table manages the terminal ID of the terminal 10 connecting to the management system 500 to which the corresponding management apparatus 60 belongs and as a request source of the start of communication and all terminal IDs of the terminals 10 registered as communicable destination candidates in association with each other. The destination list management table illustrated in FIG. 11A, for example, indicates that destination candidates the terminal 10aa with the terminal ID “01aa” as the request source can request the start of communication in a teleconference are the terminal 10ab with the terminal ID “01ab” and the like. The destination list management table also manages the terminal ID of the terminal 10 connecting to the other management system 500 as the terminal ID of the terminal 10 as a destination candidate. This enables, for example, the terminal 10aa connecting to the management system 500ab to select the terminal 10db connecting to the management system 500cd as a destination. The destination candidates are updated by addition or deletion through requests for addition or deletion from any terminal 10 to the management system 500.

Session Management Table

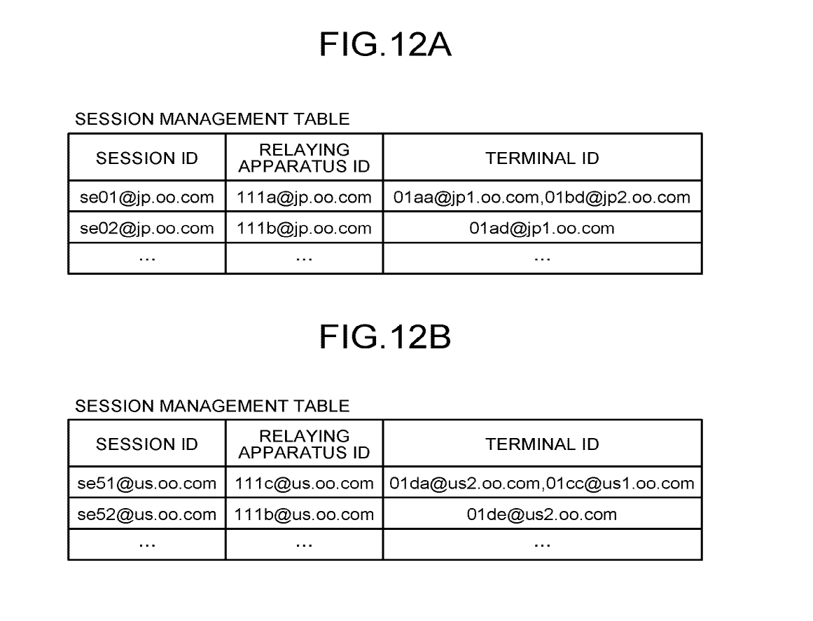

The storage unit 6000 includes a session management DB 6005 including a session management table as illustrated in FIGS. 12A and 12B. FIG. 12A is a conceptual diagram illustrating a session management table managed by the management apparatus 60ad, whereas FIG. 12B is a conceptual diagram illustrating a session management table managed by the management apparatus 60cd. The session management table manages session IDs for identifying the session sed for content data between terminals 10, relaying apparatus IDs for identifying the relaying apparatus 30 for relaying the content data in the session sed for content data, and terminal IDs for identifying the terminals 10 that are performing communication in the session sed for data content in association with each other. The session ID may be identification such as conference ID, communication ID, and call ID identifying events such as a conference, communication, a call corresponding to the session sed for content data. The session management table illustrated in FIG. 12A, for example, indicates that the relaying apparatus 30a with the relaying apparatus ID “111a” is relaying content data between terminals (10aa, 10bd) in the session sed for content data identified by the session ID “se01@jp.00.com.” In the present embodiment, the session ID includes domain information (communication control information) such as “jp.00.com” indicating the management system 500 that can perform control along with the start and end of communication with a session sed for content data identified thereby. When indicating the session ID in the following description, it will be simply denoted as “se01” or the like with the domain information such as “jp.00.com” omitted, unless particularly specified.

State Change Management Table

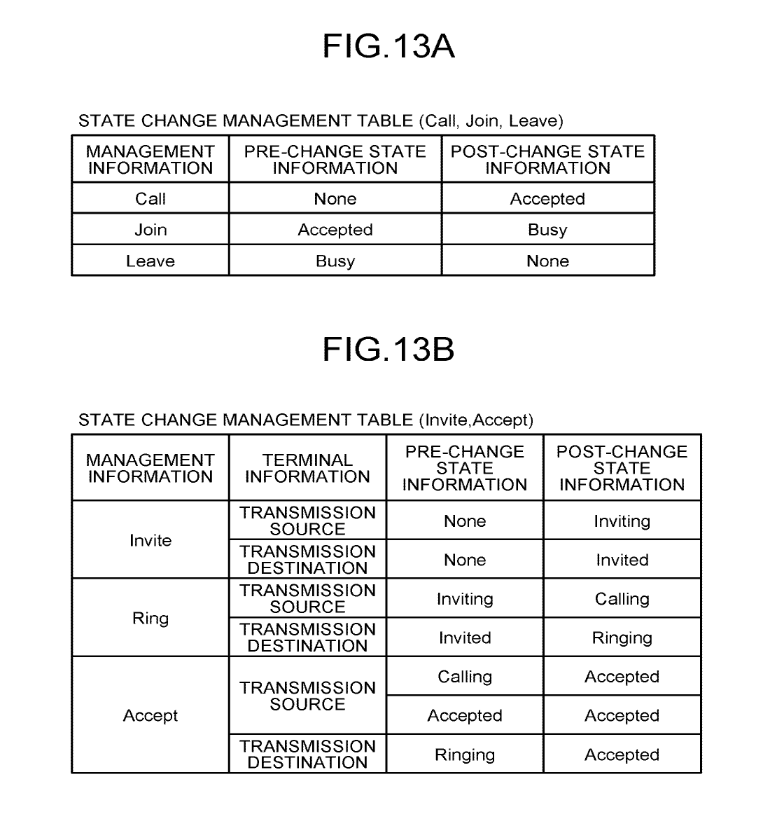

The storage unit 6000 includes a state change management DB 6009 including a state change management table as illustrated in FIGS. 13A and 13B. FIGS. 13A and 13B are conceptual diagrams illustrating the state change management tables. The state change management table illustrated in FIG. 13A manages pieces of management information transmitted from the terminal 10, pieces of pre-change state information indicating pre-change states of the terminal 10, and pieces post-change state information indicating post-change states of the terminal 10 in association with each other. The management information “Call” in the state change management table in FIG. 13A indicates that, when the session sed for content data is established between the terminals 10, the other terminal 10 requests to participate in this session. The management information “Join” indicates that the terminal 10 requests to start relaying content data. The management information “Leave” indicates that the terminal 10 requests to end communication.

When not only the state of the terminal 10 as the transmission source, but also the state of the terminal 10 as the transmission destination is changed by performing control based on the management information, the state change management table in FIG. 13B is used. In the state change management table in FIG. 13B, terminal information indicating whether the terminal 10 whose state is changed is the transmission source or the transmission destination of the management information is managed in addition to the pieces of information in FIG. 13A in association with each other. It is indicated, for example, that when the management system 500 receives the management information “Invite,” the state of communication is changed from “None” into “Inviting” for the terminal 10 as the transmission source of the management information, whereas the state of communication is changed from “None” into “Invited” for the terminal 10 as the transmission destination. The management information “Invite” indicates that the terminal 10 requests the start of communication. The management information “Ring” indicates that the terminal 10 accepts a request to start communication and sounds a dial tone. The management information “Accept” indicates that the terminal 10 permits the start of communication. The state information “Inviting” indicates a state requesting the start of communication, whereas the state information “Invited” indicates a state in which the start of communication is being requested.

Functional configurations of Management Apparatus Next, the functional configurations of the management apparatus 60 will be described. In describing the functional configurations of the management apparatus 60, the following will also describe the relation with principal components for achieving the functional configurations of the management apparatus 60 among the components illustrated in FIG. 5.

The transmitter/receiver 61 is implemented by commands from the CPU 201 illustrated in FIG. 5 and the network I/F 209 illustrated in FIG. 5 and performs the transmission and reception of various data (or information) with other apparatuses or systems via the communication network 2.

The extracting unit 64 is implemented by commands from the CPU 201 illustrated in FIG. 5, searches the respective management tables of the storage unit 6000, and extracts various information.

The storage/reading processing unit 69 is implemented by commands from the CPU 201 illustrated in FIG. 5 and the HDD 205 illustrated in FIG. 5 and performs storing various data in the storage unit 6000 and reading the various data stored in the storage unit 6000.

Functional Configuration of Controller

The controller 50 includes a transmitter/receiver 51, an authenticating unit 52, a state management unit 53, an extracting unit 54, a session management unit 57, an identifying unit 58, and a storage/reading processing unit 59. These components are functions or means that function implemented by the operation of any of the components illustrated in FIG. 5 by commands from the CPU 201 in accordance with the program for a management system loaded from the HD 204 onto the RAM 203. The management system 500 includes a nonvolatile storage unit 5000 and a volatile storage unit 5100 including the HD 204 illustrated in FIG. 5.

Terminal Management Table

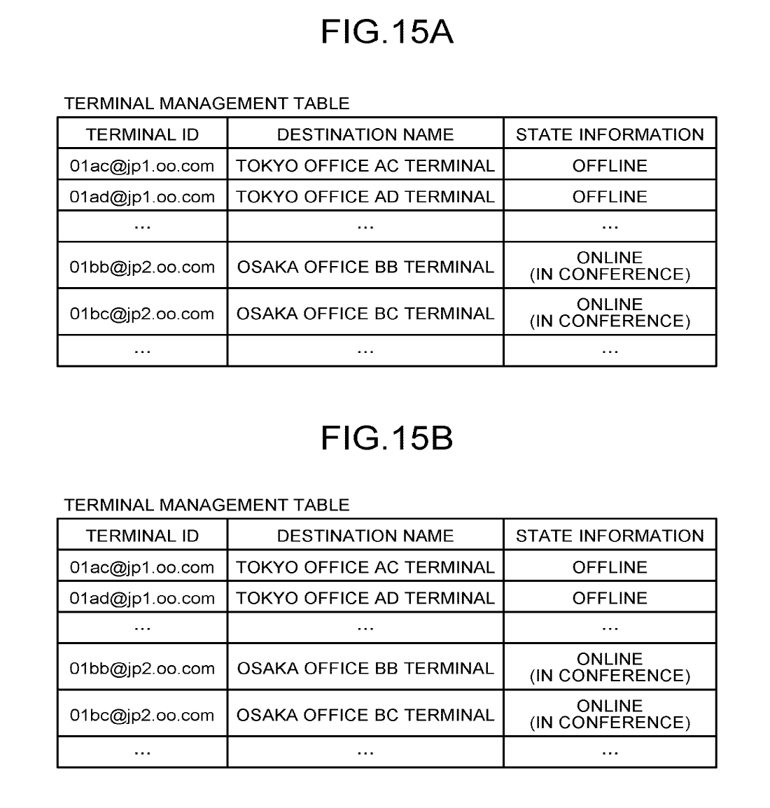

The nonvolatile storage unit 5000 includes a terminal management DB 5003 including a terminal management table as illustrated in FIGS. 15A and 15B. FIG. 15A is a conceptual diagram illustrating a terminal management table managed by the controller 50a, whereas FIG. 15B is a conceptual diagram illustrating a terminal management table managed by the controller 50b. The terminal management table manages the terminal IDs of the respective terminals 10, destination names with the respective terminals 10 as destinations, and the operation states of the respective terminals 10 in association with each other. In the present embodiment, the operation states include the state of the connection between the terminal 10 and the controller 50 (online, online (in conference), and offline). “Online” among the operation states is a state in which the terminal 10 and the controller 50 are connected, and communication with the other terminal 10 is capable. “Online (in conference)” among the operation states is a state in which the terminal 10 and the controller 50 are connected, and communication with the other terminal 10 is in progress. “Offline” among the operation states is a state in which the terminal 10 and the controller 50 are not connected, and communication with the other terminal 10 is incapable. The terminal management table illustrated in FIG. 15A, for example, indicates that the destination name of the terminal 10aa with the terminal ID “01aa” is “Tokyo Office AA terminal” and the operation state thereof is “offline.”

Functional Configurations of Controller Next, the functional configurations of the controller 50 will be described in detail. In describing the functional configurations of the controller 50, the following will also describe the relation with principal components for achieving the functional configurations of the controller 50 among the components illustrated in FIG. 5.

The transmitter/receiver 51 is implemented by commands from the CPU 201 illustrated in FIG. 5 and the network I/F 209 illustrated in FIG. 5 and performs the transmission and reception of various data (or information) with the other terminals, apparatuses, or systems via the communication network 2. This causes the transmitter/receiver 51 to receive start request information from the terminal 10, thereby accepting a request for the start of communication. Relaying apparatus connection information for connecting to the relaying apparatus 30 is transmitted to the terminal 10, thereby performing control along with the start of communication. The transmitter/receiver 51 transmits participation notification (start information) including the terminal ID and the session ID of the terminal 10 participating in the session sed for content data to the terminal 10 that is performing communication in this session. The transmitter/receiver 51 receives or transmits post-change state information indicating the post-change state of the terminal 10.

The authenticating unit 52 is implemented by commands from the CPU 201 illustrated in FIG. 5 and performs terminal authentication by searching the terminal authentication management table (refer to FIG. 9) of the storage unit 6000 with the terminal ID and the password included in the login request information received via the transmitter/receiver 51 as search keys and determining whether the same terminal ID and password are managed by the terminal authentication management table.

The state management unit 53 is implemented by commands from the CPU 201 illustrated in FIG. 5, and in order to manage the operation state of a request source terminal that requested a login, stores the terminal IDs of the request source terminals and the operation states of the request source terminals in association with each other in the terminal management table (refer to FIG. 15) and manage them. A first changing unit 53a of the state management unit 53 changes the operation state managed by the terminal management table when the operation state of the terminal 10 is changed based on control by the corresponding controller 50. A second changing unit 53b of the state management unit 53 changes the operation state managed by the terminal management table based on post-change state information transmitted from the other controller 50 when the operation state of the terminal 10 is changed based on control by the other controller 50.

The extracting unit 54 is implemented by commands from the CPU 201 illustrated in FIG. 5 and extracts the terminal ID by searching the destination list management table (refer to FIG. 11) with the terminal ID of the request source terminal that requested a login as a key and reading the terminal ID of the terminal 10 as a destination candidate. The extracting unit 54 searches a destination management table with the terminal ID of the request source terminal that requested a login as a key and also extracts the terminal ID of the other request source terminal that registers the terminal ID of the above request source terminal as a candidate for the destination terminal.

The extracting unit 54 is implemented by commands from the CPU 201 illustrated in FIG. 5, searches the terminal management table (refer to FIG. 15) with the terminal ID of the candidate for the destination terminal as a search key, and reads the operation states of the respective terminal IDs. This enables the extracting unit 54 to extract the operation state of the candidate for the destination terminal that can communicate with the request source terminal that requested a login. The extracting unit 54 searches the terminal management table with the terminal ID as a search key and also acquires the operation state of the request source terminal that requested a login.

The session management unit 57 is implemented by commands from the CPU 201 illustrated in FIG. 5, and each time the session sed for content data between the terminals 10 is newly established, generates session ID for identifying the session sed for content data. The session management unit 57 stores in the session management table (refer to FIGS. 12A and 12B) the terminal ID for identifying the terminal 10 that performs communication in this session and the relaying apparatus ID of the relaying apparatus 30 used in this session in association with each other.

The identifying unit 58 is implemented by commands from the CPU 201 illustrated in FIG. 5 and identifies the other controller 50 in operation arranged in the same segment.

The storage/reading processing unit 59 is implemented by commands from the CPU 201 illustrated in FIG. 5 and the HDD 205 illustrated in FIG. 5 and performs storing various data in the nonvolatile storage unit 5000 or the volatile storage unit 5100 and reading the various data stored in the nonvolatile storage unit 5000 or the volatile storage unit 5100.

Functional Configuration of Selecting Apparatus

The selecting apparatus 80 includes a transmitter/receiver 81, a selecting unit 82, and a storage/reading processing unit 89. These components are functions or means that function implemented by the operation of any of the components illustrated in FIG. 5 by commands from the CPU 201 in accordance with the program for a management system loaded from the HD 204 onto the RAM 203. The selecting apparatus 80 includes a storage unit 8000 including the HD 204 illustrated in FIG. 5.

Relaying Apparatus Selection Management Table

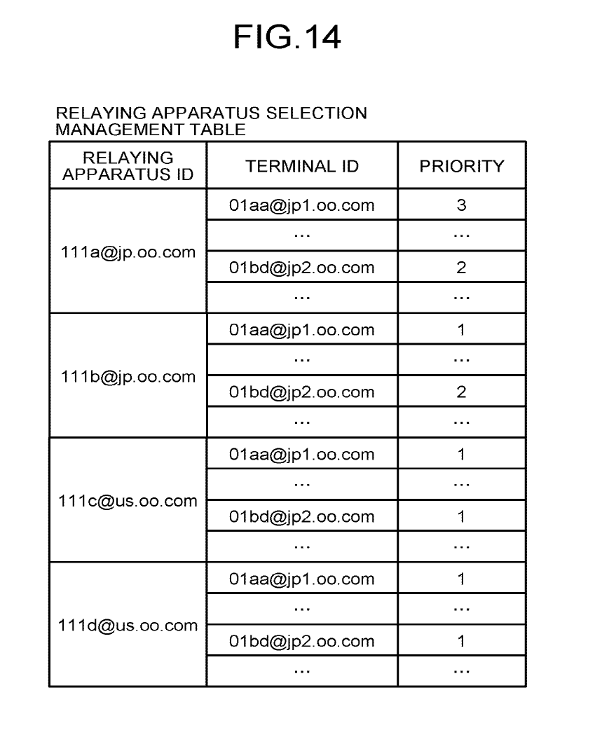

The storage unit 8000 includes a relaying apparatus selection management DB 8001 as an example of a communication control information management unit including a relaying apparatus selection management table as illustrated in FIG. 14. FIG. 14 is a conceptual diagram illustrating the relaying apparatus selection management table. When selecting a relaying apparatus for use in relaying information transmitted and received between the terminals 10, the relaying apparatus selection management table manages, for all relaying apparatuses 30 as candidates for selection, relaying apparatus IDs for identifying the relaying apparatuses 30. The relaying apparatus ID managed by the relaying apparatus selection management table includes domain information (communication control information) such as “jp.00.com” indicating the management system 500 that can perform control along with the start of communication using the relaying apparatus 30 identified thereby. The relaying apparatus selection management table manages priority information indicating priority when selecting the relaying apparatus 30 identified by the relaying apparatus ID for the respective terminal IDs. The relaying apparatus selection management table illustrated in FIG. 14 indicates that when the terminal 10aa identified by the terminal ID “01aa” starts communication, the priority when selecting the relaying apparatus 30a identified by the relaying apparatus ID “111a” is “3.” The priority in the relaying apparatus selection management table is set so that a higher priority gives a higher value based on a bandwidth between the terminal 10 and the relaying apparatus 30 or a delay time when information is transmitted and received between the terminal 10 and the relaying apparatus 30, for example.

The priority may be calculated based on time zones used by the terminal 10 and the management system 500. In this case, the value of the priority can be set higher as the time zone used by the terminal 10 and the time zone used by the management system 500 become close to each other, for example.

Functional Configurations of Selecting Apparatus

Next, the functional configurations of the selecting apparatus 80 will be described in detail. In describing the functional configurations of the selecting apparatus 80, the following will also describe the relation with principal components for achieving the functional configurations of the selecting apparatus 80 among the components illustrated in FIG. 5.

The transmitter/receiver 81 is an example of a selection request information accepting unit and an output unit, is implemented by commands from the CPU 201 illustrated in FIG. 5 and the network I/F 209 illustrated in FIG. 5, and performs the transmission and reception of various data (or information) with the other terminals, apparatuses, or systems via the communication network 2. This causes the transmitter/receiver 81 to receive (accept) selection request information indicating a request to select the relaying apparatus 30 transmitted from the management system 500. The transmitter/receiver 81 transmits (outputs) the relaying apparatus ID identifying the relaying apparatus 30 selected by the selecting apparatus 80 to the management system 500.

The selecting unit 82 is an example of a relaying apparatus selection unit and a communication control information extracting unit and selects at least one relaying apparatus 30 out of a plurality of relaying apparatuses 30 as candidates based on the priority information managed by the relaying apparatus selection management table (refer to FIG. 14). The selecting unit 82 selects the relaying apparatus ID managed by the relaying apparatus selection management table, thereby also extracting the domain information included in the relaying apparatus ID.

The storage/reading processing unit 89 is implemented by commands from the CPU 201 illustrated in FIG. 5 and the HDD 205 illustrated in FIG. 5 and performs storing various data in the storage unit 8000 and reading the various data stored in the storage unit 8000.

Operation of Embodiment

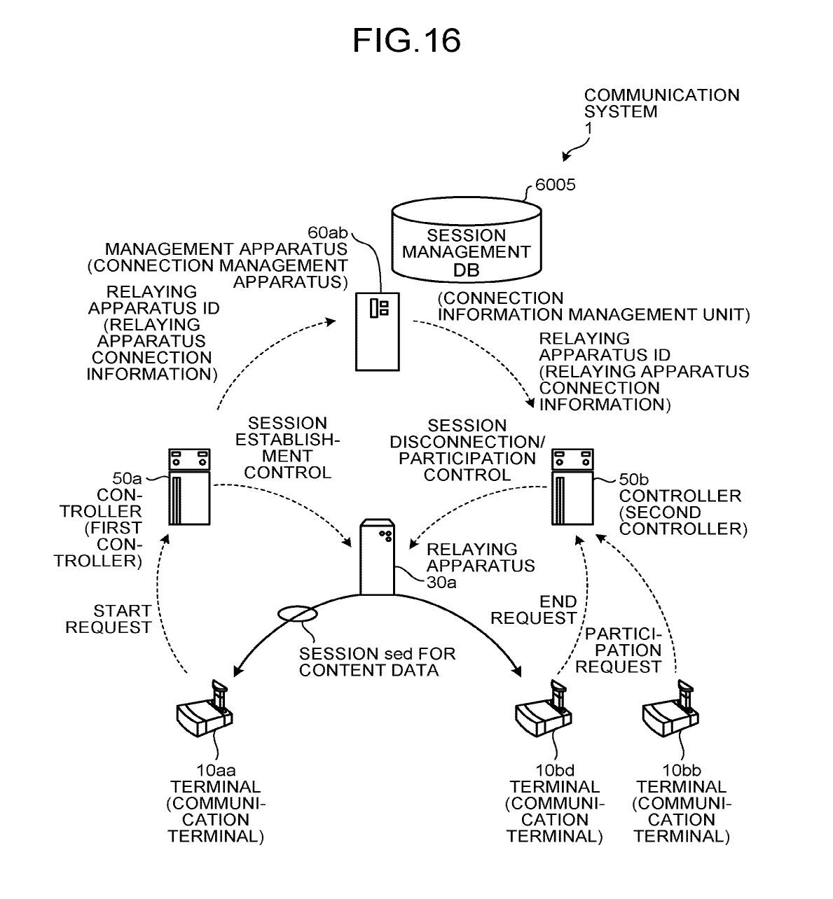

Next, the operation performed by the controller 50, the management apparatus 60, and the terminal 10 will be described with reference to FIG. 16. FIG. 16 is a conceptual diagram illustrating the state of the transmission and reception of various information in the communication system 1.

When the session sed for content data that transmits content data between the terminal 10aa and the terminal 10bd via the relaying apparatus 30a is established based on control by the controller 50a (an example of a first controller), the session management DB 6005 (an example of a connection information management unit) of the management apparatus 60ab (an example of a connection management apparatus) manages the relaying apparatus ID (an example of the relaying apparatus connection information) of the relaying apparatus 30a used to connect to the relaying apparatus 30a that relays the content data transmitted between the terminals 10 in this session.

When control that is related to this session and includes connection to the relaying apparatus 30a is performed by the controller 50b (an example of a second controller), the relaying apparatus ID of the relaying apparatus 30a managed by the session management DB 6005 is transmitted to the controller 50b. This enables the control that is related to this session and includes the connection to the relaying apparatus 30a to be performed in a distributed manner by a plurality of controllers (50a, 50b), thereby reducing a load imposed on the controller 50.

Examples of the control including the connection to the relaying apparatus 30a may include control for disconnecting the session sed for content data and control for causing a new communication terminal to participate in the session sed for content data while this session is established.

The management system 500ab includes the management apparatus 60ab and the controllers (50a, 50b, . . . ). By thus scaling out the controller 50, loads on the respective controllers 50 can be distributed.

The transmitter/receiver 51 (an example of a transmitter) of the controller 50a transmits the relaying apparatus ID of the relaying apparatus 30a that relays the content data in the above session to the management apparatus 60ab. This enables the management apparatus 60ab to manage the relaying apparatus connection information used for connecting to the relaying apparatus 30a that relays the content data transmitted between the terminals 10 in this session.

The transmitter/receiver 51 (an example of a connection information receiver) of the controller 50b receives the relaying apparatus ID of the relaying apparatus 30a from the management apparatus 60ab. The controller 50b can perform control that is related to this session and includes the connection to the relaying apparatus 30a based on the received relaying apparatus ID.

The state management DB 6003 (an example of a state management unit) of the management apparatus 60 manages pieces of state information indicating the state of communication of the respective terminals 10. When performing control related to the session for content data by the corresponding controller 50, the first changing unit 53a (an example of a first changing unit) of each controller 50 changes the state information of a terminal related to this session among the pieces of state information managed by the state management DB 6003 into state information indicating the state of communication after being changed by this control. When the control related to this session is performed by the other controller 50, the transmitter/receiver 51 (an example of a receiver) of each controller 50 receives changed state information indicating the state of communication of the terminal 10 related to this session after being changed by this control from the other controller 50. The second changing unit 53b (an example of a second changing unit) of each controller 50 changes the state information of a terminal related to this session among the pieces of state information managed by the state management DB 6003 based on the changed state information. This enables each controller 50, even when the control related to this session is performed by the other controller 50, to accurately grasp the state of the terminal 10 related to the session, thereby, when performing the control related to the session by the corresponding controller 50 next time, enabling to accurately perform the control based on the state of the terminal 10.

The controllers (50a, 50b) are located within the same domain. This enables the controller 50, when the control related to the session sed for content data is performed by the other controller 50, to grasp the state of the terminal 10 related to this session in real time.

Each controller 50 includes an identifying unit 58 that identifies the other controller 50 located in the same domain. This enables each controller 50 to automatically identify the transmission destination of the changed state information.

The communication system 1 according to the present embodiment includes the management system 500, the terminal 10, and the relaying apparatus 30 that relays content data between the terminals 10.

Next, operation performed in the communication system 1 according to the present embodiment will be described.

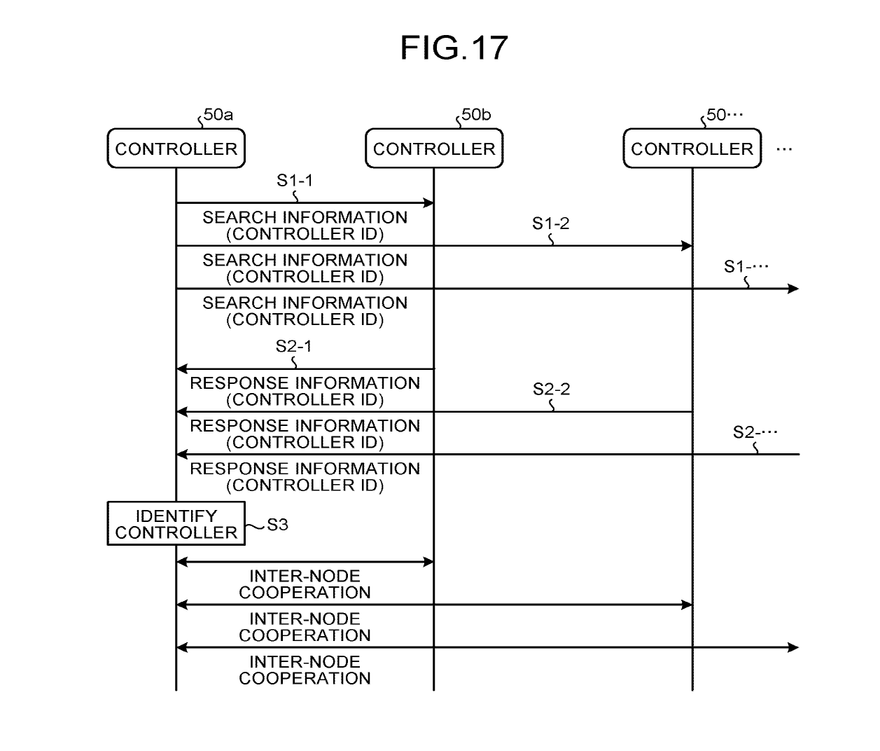

Inter-controller Coordination First, inter-node cooperation between the controllers 50 present within the same domain will be described with reference to FIG. 17. FIG. 17 is a sequence diagram illustrating procedure of the inter-node cooperation. As illustrated in FIG. 17, the controller 50a performs search for the other controller 50 arranged in the same segment (Steps S1-1, S1-2, In this case, the transmitter/receiver 51 of the controller 50a transmits, by broadcast, search information used for search to the segment in which the controller 50a is located. The search information includes a controller ID for identifying the controller 50a. The transmitter/receiver 51 of each controller 50 that has received the search information from the controller 50a transmits response information to the controller 50a (Steps S2-1, S2-2, The response information includes each controller ID for identifying each controller 50 that has received the search information. When the transmitter/receiver 51 of the controller 50a receives the response information from the other controllers 50, the identifying unit 58 identifies the other controller 50 being in operation located in the same segment based on the response information (Step S3).

When the controller 50 being in operation located in the same segment is identified at Step S3, the controller 50a performs the inter-node cooperation with the identified controller (50b, 50 . . . ). In an embodiment according to the present invention, the inter-node cooperation means that one controller 50 is regarded as a node, a plurality of controllers 50 have the same domain name, and the controllers 50 can be operated cooperatively with each other. When the controller 50a and the controller 50b perform the inter-node cooperation, for example, the controller 50a and the controller 50b operate as if they are the same controller 50. In other words, both when the terminal 10 connects to the controller 50a and when it connects to the controller 50b, the same operation is performed in the controllers 50a and 50b.

The inter-node cooperation is performed at given time intervals. This enables the controller 50a to perform inter-node release when the controller 50 cooperated with the controller 50a undergoes maintenance or goes down. This causes the controllers 50 in inter-node cooperation, even when inter-node cooperation or release with any controller 50 constituting the management system 500ab is performed, to operate as if they operate singly.

Also for the controller 50 other than the controller 50a constituting the management system 500ab, the inter-node cooperation with the other controller 50 present in the same domain is performed. This procedure is similar to the processes at Steps S1 to S3, and the description thereof is omitted.

State Management

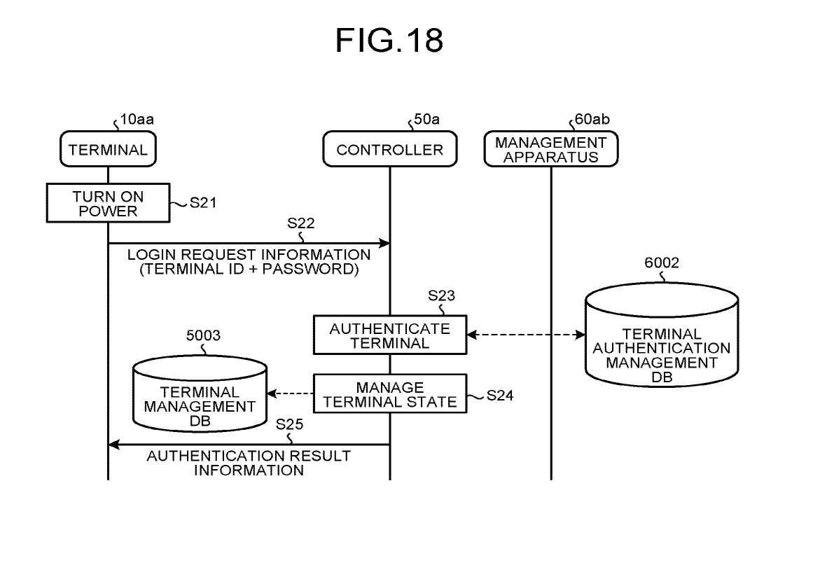

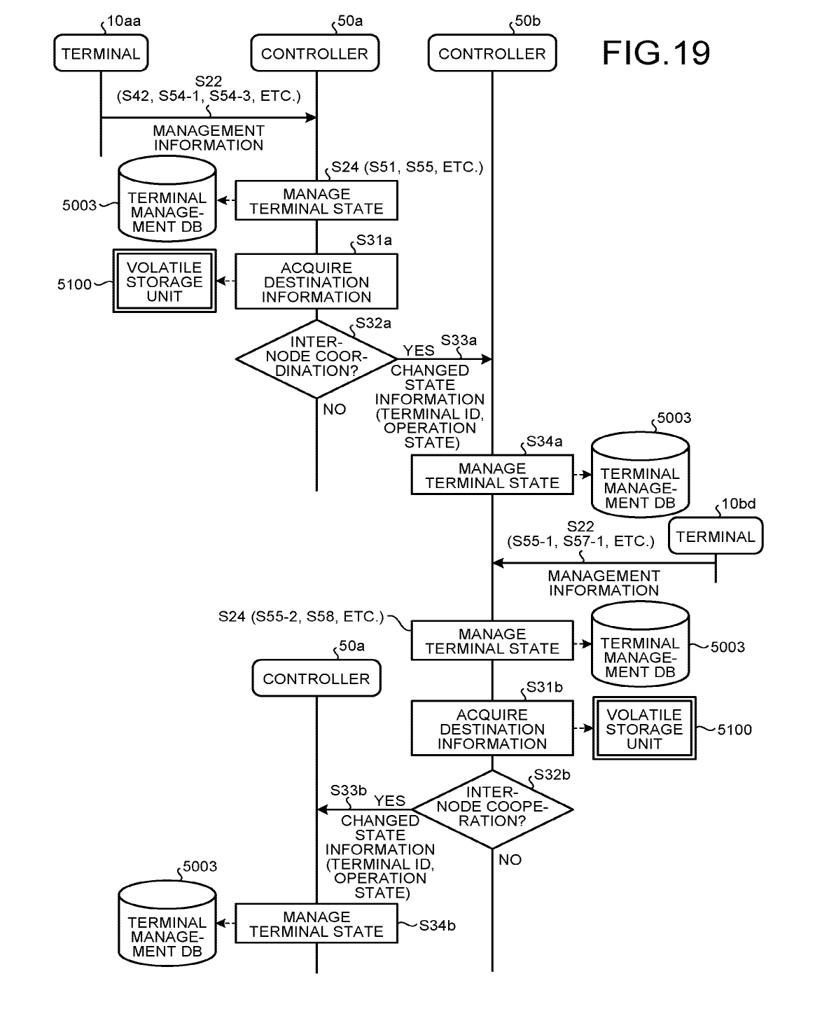

As an example of the inter-node cooperation, the following describes coincidence of the operation states of the terminals 10, which are managed by the controllers 50 constituting the management system 500ab, between the controllers 50 with reference to FIG. 18 and FIG. 19. FIG. 18 is a sequence diagram illustrating the procedure of a preparatory stage for starting communication between terminals. FIG. 19 is a sequence diagram illustrating procedure of making the operation states of terminals coincide between controllers. In FIG. 18 and FIG. 19, various management information is transmitted and received entirely in the session sei for management information illustrated in FIG. 2.

First, when the user of the terminal 10aa turns on the power switch 109 illustrated in FIG. 4, the operation input accepting unit 12 illustrated in FIG. 6 accepts the power-on and turns on the power (Step S21). The login requesting unit 13 automatically transmits login request information indicating a login request to the controller 50a via the communication network 2 with the acceptance of the power-on as a trigger (Step S22). The trigger for transmitting the login request information is not limited to the power-on and may be the acceptance of operation input by the user via the operation input accepting unit 12. The present embodiment continues to describe on the assumption that the terminals (10aa, 10ab, . . . ) connecting to the LAN 2a connects to the controller 50a, the terminals (10ba, connecting to the LAN 2b connects to the controller 50b, the terminals (10ca, 10cb, . . . ) connecting to the LAN 2c connects to the controller 50c, and the terminals (10da, 10db, . . . ) connecting to the LAN 2d connects to the controller 50d. The login request information includes a terminal ID for identifying the terminal 10aa as the request source or the user of the terminal 10aa and a password. The terminal ID and the password are pieces of data read from the storage unit 1000 via the storage/reading processing unit 19 and transmitted to the transmitter/receiver 11. The terminal ID in this example is merely an example of information for use in authentication, and the login request information is only required to include at least identification for identifying the terminal 10 or the user of the terminal 10 and information for identifying the controller 50 to which the terminal 10 connects and is not limited to this form.

Next, the authenticating unit 52 of the controller 50a requests to authenticate by determining whether the terminal ID and the password included in the login request information received via the transmitter/receiver 51 is managed by the terminal authentication management table (refer to FIG. 9) (Step S23). In this case, the transmitter/receiver 51 of the controller 50a transmits the terminal ID and the password included in the login request information to the management apparatus 60ab and searches the terminal authentication management table, thereby requesting to search for the password corresponding to this terminal ID. The extracting unit 64 of the management apparatus 60ab extracts the password corresponding to the terminal ID included in the login request information in the terminal authentication management table. If the extracted password and the password transmitted from the controller 50a match, the transmitter/receiver 61 of the management apparatus 60ab transmits an authentication result indicating that the terminal 10aa has a valid authority to the controller 50a. If the extracted password and the password transmitted from the controller 50a do not match, the transmitter/receiver 61 of the management apparatus 60ab transmits an authentication result indicating that the terminal 10aa do not have a valid authority to the controller 50a. The authenticating unit 52 manages the same terminal ID and password, and when determined to be a login request from the terminal 10 having the valid authority, the first changing unit 53a of the state management unit 53 stores, in the terminal management table (refer to FIG. 15A), the terminal ID of the terminal 10aa and the state information indicating the operation state in association with each other (Step S24). With this, the terminal ID “01aa” and the state information “Online” are managed by the terminal management table in association with each other.

The transmitter/receiver 51 of the controller 50a transmits authentication result information indicating the authentication result obtained by the authenticating unit 52 to the terminal 10aa as the request source that requested the login via the communication network 2 (Step S25). The present embodiment continues to describe below the case determined to be a terminal having a valid authority by the authenticating unit 52.

When the operation state of the terminal 10 managed by the terminal management table of each controller 50 is changed (refer to Step S24), the controllers 50 subjected to the inter-node cooperation make the operation states of terminals coincide with the changed operation states. The following describes a case of making the operation states coincide between the controller 50a and the controller 50b. When the operation state managed by the terminal management table (refer to FIG. 15A) is changed by the first changing unit 53a based on various management information from the terminal 10 (the terminal 10aa in this example) connecting to the controller 50a, the storage/reading processing unit 59 stores in the volatile storage unit 5100 the terminal ID “01aa” of the terminal 10aa and the operation state (Offline, for example) indicating the changed state of the terminal 10aa in association with each other as local data for coincidence (Step S31a).

Next, if there is another controller subjected to the inter-node cooperation (Step S32a), the transmitter/receiver 51 of the controller 50a transmits changed state information indicating the changed state information to the controller 50b subjected to the inter-node cooperation (Step S33a). The changed state information includes the local data for coincidence stored in the volatile storage unit 5100, that is, the terminal ID “01aa” and the operation state “Offline.”

The changed state information transmitted from the controller 50a is received by the transmitter/receiver 51 of the controller 50b. The second changing unit 53b of the state management unit 53 of the controller 50b changes the operation state managed in association with the terminal ID “01aa” into “Offline” based on the changed state information in the terminal management table (refer to FIG. 15B) (Step S34a).

In a similar manner to the processes at Step S24 and the like, when the operation state of the terminal 10 managed by the terminal management table of the controller 50b is changed by the first changing unit 53a of the controller 50b, the other controller 50a subjected to the inter-node cooperation makes the operation states coincide with the changed operation state. This procedure is similar to the processes at Step S31a to Step S34a, and the description thereof is omitted (Step S31b to Step S34b).

Relaying Apparatus Selection Operation

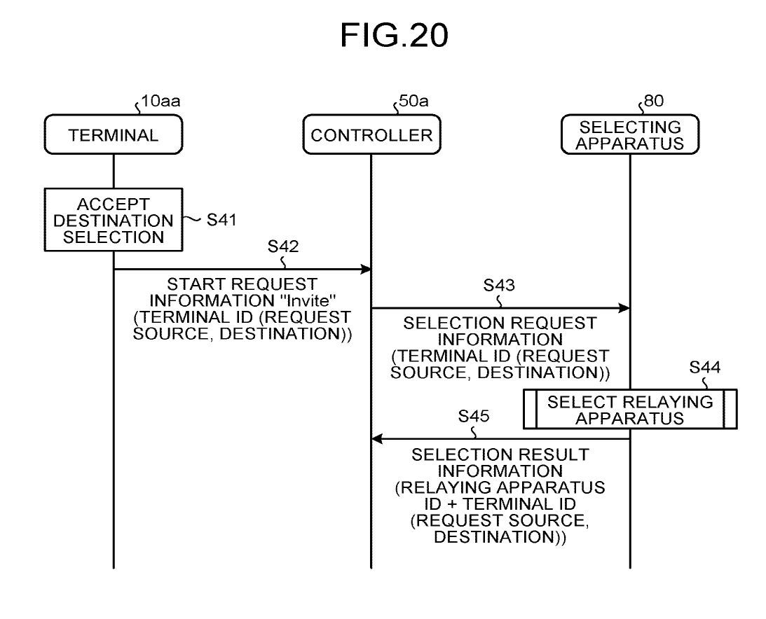

The following describes operation to select the relaying apparatus 30 for use in relaying content data transmitted and received between the terminals 10 before starting communication between the terminal 10aa and the terminal 10bd with reference to FIG. 20. FIG. 20 is a sequence diagram illustrating procedure to select a relaying apparatus. In FIG. 20, various management information is transmitted and received entirely in the session sei for management information illustrated in FIG. 2.

First, the user of the terminal 10aa presses down the operation button 108 illustrated in FIG. 3 to select the terminal 10bd as a destination candidate, thereby causing the operation input accepting unit 12 illustrated in FIG. 6 to accept a request to start communication (Step S41). The transmitter/receiver 11 of the terminal 10aa transmits, to the controller 50a, the start request information “Invite” that includes the terminal ID “01aa” of the terminal 10aa as the request source of the start of communication and the terminal ID “01bd” of the terminal 10bd as a destination and indicates request to start communication (Step S42).

The transmitter/receiver 51 of the controller 50a receives the start request information, thereby accepting the request to start communication between the terminal 10aa and the terminal 10bd. The transmitter/receiver 51 then transmits to the selecting apparatus 80 the selection request information that includes the terminal ID “01aa” of the terminal 10aa and the terminal ID “01bd” of the terminal 10bd and indicates a request to select the relaying apparatus 30 for use in relaying content data transmitted and received between the terminal 10aa and the terminal 10bd (Step S43).

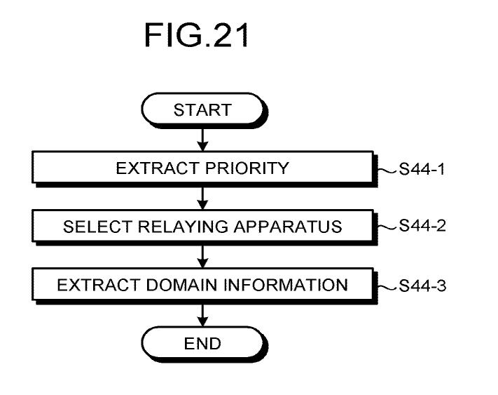

The transmitter/receiver 81 of the selecting apparatus 80 receives the selection request information, thereby accepting the request to select the relaying apparatus 30. The selecting unit 82 then selects at least one relaying apparatus 30 for use in relaying the content data transmitted and received between the terminal 10aa and the terminal 10bd out of the relaying apparatuses 30 managed by the relaying apparatus selection management table (refer to FIG. 14) (Step S44). The operation to select the relaying apparatus 30 will be described in more detail with reference to FIG. 21. FIG. 21 is a flow diagram illustrating procedure to select a relaying apparatus.

First, the selecting unit 82 extracts priority associated with the terminal ID “01aa” of the terminal 10aa as the request source and priority associated with the terminal ID “01bd” of the terminal 10bd as the destination for the respective relaying apparatus IDs managed by the relaying apparatus selection management table (refer to FIG. 14) (Step S44-1). The selecting unit 82 then calculates the sum of the extracted priority for the respective relaying apparatus IDs and selects the relaying apparatus ID whose calculated sum of the priority is the largest (Step S44-2). In the present embodiment, the sum of the priority corresponding to the relaying apparatus ID “111a” is “5,” which is the largest. The selecting unit 82 selects the relaying apparatus ID managed by the relaying apparatus selection management table, thereby also extracting the domain information included in the relaying apparatus ID (Step S44-3).

Upon completion of the selection of the relaying apparatus 30, the transmitter/receiver 81 of the selecting apparatus 80 transmits (outputs) to the controller 50a selection result information that includes the relaying apparatus ID identifying the selected relaying apparatus, the terminal ID “01aa” of the terminal 10aa, and the terminal ID “01bd” of the terminal 10bd and indicates the result of the selection (Step S45).

Communication Start Operation

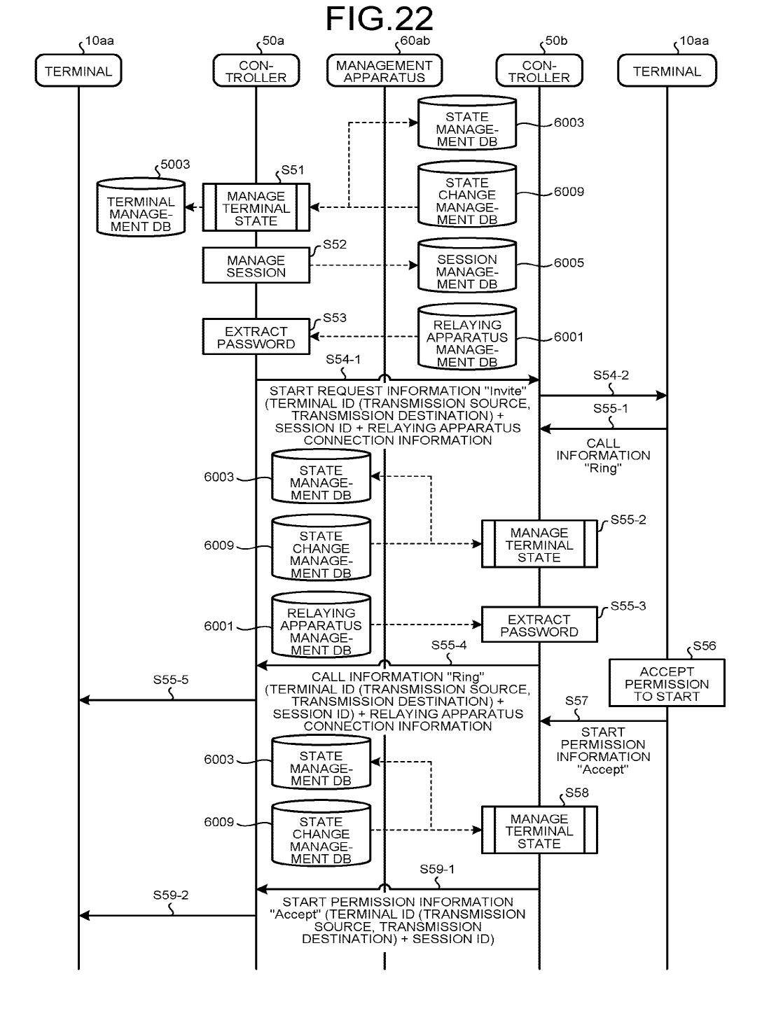

Next, control along with the start of communication will be described with reference to FIG. 22. FIG. 22 is a sequence diagram illustrating procedure to request the start of communication. In FIG. 22, various management information is transmitted and received entirely by the session sei for management information illustrated in FIG. 2.

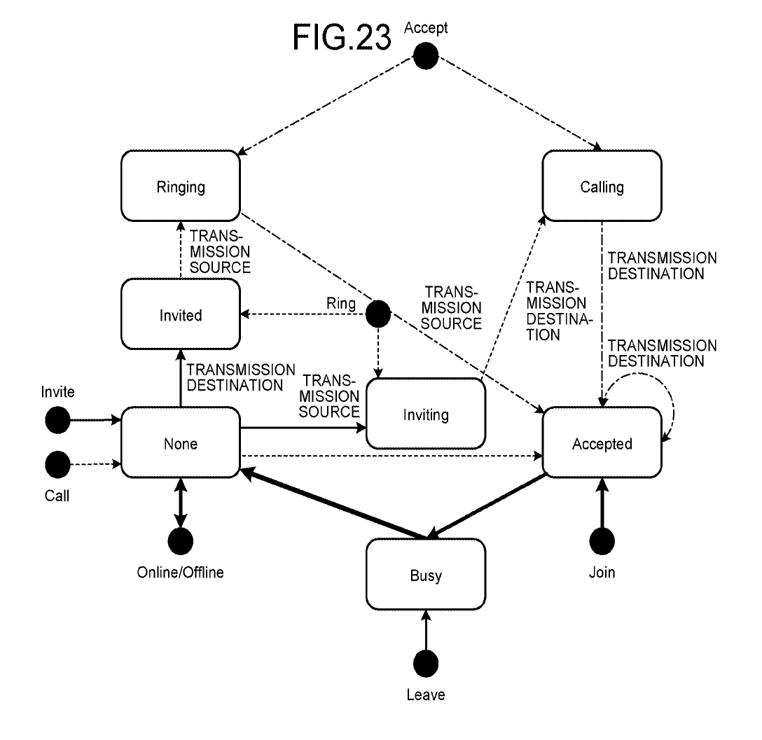

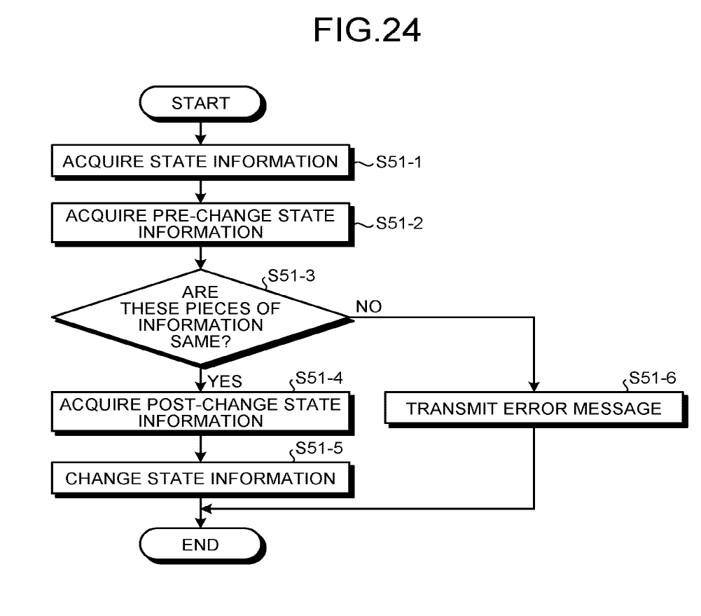

First, the state management unit 53 changes the state information of the terminal 10 related to a start request among the terminals 10 managed by the state management table (refer to FIG. 10A) based on the start request information “Invite” transmitted from the terminal 10aa at Step S42 (Step S51). The process at Step S51 will be described in detail with reference to FIG. 23 and FIG. 24. FIG. 23 is a state transition diagram illustrating transitions between states of a terminal. FIG. 24 is a flow diagram illustrating procedure to change the state of a terminal.

In the present embodiment, the state management unit 53 changes the state of the terminal 10 in accordance with the rules about changes of the state illustrated by the state transition diagram in FIG. 23. When receiving the start request information “Invite” from the terminal 10, for example, the state information “None” of the terminal 10 is changed into the state information “Inviting” or the state information “Invited.” Also when management information “Ring”, “Accept”, “Join”, and “Leave” other than “Invite” is transmitted from the terminal 10, the state management unit 53 changes the state of the terminal 10 in accordance with the rules about changes illustrated by the state transition diagram in FIG. 23. The detailed description thereof is omitted. Although the present embodiment will describe an example using the state change management table (refer to FIGS. 13A and 13B) in order to achieve changes of the state by the state management unit 53, it is not limited to the method using the state change management table so long as a communication state can be changed in accordance with the rules illustrated in FIG. 23.

First, the state management unit 53 acquires the state information “None” of the terminal 10aa as the transmission source of the start request information and the state information of the terminal 10bd as the transmission destination from the state management table (refer to FIG. 10A) (Step S51-1). In this case, the state management unit 53 of the controller 50a transmits the terminal ID of the terminal 10aa as the start request source and the terminal ID of the terminal 10bd as the transmission destination of the start request information to the management apparatus 60ab via the transmitter/receiver 51, thereby requesting to extract corresponding pieces of state information. The extracting unit 64 of the management apparatus 60ab extracts the pieces of state information corresponding to the respective terminal IDs from the state management table. The extracted pieces of state information are transmitted to the controller 50a via the transmitter/receiver 61.

Next, the state management unit 53 acquires the pre-change state information “None” of the terminals 10 as the transmission source and the transmission destination corresponding to the start request information “Invite” as management information from the state change management table (refer to FIG. 13B) (Step S51-2). In this case, the state management unit 53 of the controller 50a transmits the start request information “Invite” to the management apparatus 60ab via the transmitter/receiver 51 and searches the state change management table, thereby requesting to search for the pre-change state information corresponding to this start request information. The extracting unit 64 of the management apparatus 60ab extracts the pre-change state information corresponding to the start request information in the state change management table. The extracted pre-change state information is transmitted to the controller 50a via the transmitter/receiver 61. Next, the state management unit 53, for the terminal 10aa as the transmission source and the terminal 10bd as the transmission destination separately, compares the state information acquired from the terminal management table and the pre-change state information acquired from the state change management table (refer to FIGS. 13A and 13B) and determines whether these are the same (Step S51-3).

If it is determined that these pieces of information are the same (Yes at Step S51-3), the state management unit 53 acquires the post-change state information “Inviting” of the transmission source and the post-change state information “Invited” of the transmission destination of the start request information “Invite” from the state change management table (Step S51-4). In this case, the state management unit 53 of the controller 50a transmits the start request information “Invite” to the management apparatus 60ab via the transmitter/receiver 51 and searches the state change management table, thereby requesting to search for the post-change state information corresponding to this start request information. The extracting unit 64 of the management apparatus 60ab extracts the post-change state information corresponding to the start request information in the state change management table. The extracted post-change state information is transmitted to the controller 50a via the transmitter/receiver 61.

Next, the first changing unit 53a of the state management unit 53 changes the state information associated with the terminal ID “01aa” of the terminal 10aa as the transmission source into “Inviting” based on the acquired post-change state information in the state management table (refer to FIG. 10A) (Step S51-5). Similarly, the first changing unit 53a of the state management unit 53 changes the state information associated with the terminal ID “01bd” of the terminal 10bd as the transmission destination into “Invited” based on the acquired post-change state information in the terminal management table. In this case, the state management unit 53 of the controller 50a transmits the terminal IDs of the terminals (10aa, 10bd) as the start request source and the transmission destination of the start request information and the pieces of post-change state information of the respective terminals 10 to the management apparatus 60ab via the transmitter/receiver 51, thereby requesting to update the pieces of state information. The storage/reading processing unit 69 of the management apparatus 60ab changes the pieces of state information corresponding to the respective terminal IDs based on the received pieces of state information, thereby updating the state management table.

After the pieces of state information of the respective terminals (10aa, 10bd) are changed by the first changing unit 53a of the controller 50a, the first changing unit 53a changes the operation states of the respective terminals (10aa, 10bd) managed by the terminal management table (refer to FIG. 16) from “Online” into “Online (in conference)”. The post-change operation states are made coincide between the controller 50a and the controller 50b based on the processes at Step S31a to Step S34a.

If it is determined that the pieces of information are not the same at Step S51-3, it is considered that any terminal 10 is not in a state that can start communication, and the state management unit 53 does not perform the operation to change the states of the respective terminals 10. In this case, the transmitter/receiver 51 transmits an error message to the terminal 10aa (Step S51-6), and the operation ends.

Upon end of the operation to change the state information of the terminal 10, the session management unit 57 generates the session ID “se01@jp.00.com” for identifying the session sed for content data for performing communication between the terminal 10aa and the terminal 10bd (Step S52). The session management unit 57 records the generated session ID, the relaying apparatus ID “111a” of the selected relaying apparatus 30a, and the terminal IDs “01aa” and “01bd” of the respective terminals (10aa, 10bd) that start communication in association with each other in the session management table (refer to FIGS. 12A and 12B). In this case, the session management unit 57 of the controller 50a transmits the above session ID, relaying apparatus ID, and terminal IDs to the management apparatus 60ab via the transmitter/receiver 51, thereby requesting to record these pieces of information in the session management table. The storage/reading processing unit 69 of the management apparatus 60ab records the generated session ID, the relaying apparatus ID “111a” of the selected relaying apparatus 30a, and the terminal IDs “01aa” and “01bd” of the respective terminals (10aa, 10bd) that start communication in association with each other in the session management table.

The session management unit 57 searches the relaying apparatus management table (FIGS. 8A and 8B) with the relaying apparatus ID “111a” of the selected relaying apparatus 30a as a key, thereby extracting the corresponding password “xxxx” (Step S53). In this case, the session management unit 57 of the controller 50a transmits the above session ID and relaying apparatus ID to the management apparatus 60ab via the transmitter/receiver 51, thereby requesting to provide notification of the corresponding password. The extracting unit 64 of the management apparatus 60ab extracts the password corresponding to the relaying apparatus ID from the relaying apparatus management table. The extracted password is transmitted to the controller 50a via the transmitter/receiver 61.

Next, the transmitter/receiver 51 of the controller 50a transmits the start request information “Invite” transmitted from the terminal 10aa at Step S42 and the session ID “se01” to the terminal 10bd via the controller 50b (Steps S54-1, S54-2). The terminal ID of the terminal 10bd as the transmission destination of the start request information includes the domain information “jp2.oo.com,” and the transmitter/receiver 51 can transmit the start request information via the controller 50b based on this domain information. The start request information includes the terminal ID “01aa” of the terminal 10aa as the transmission source of the start request information and the terminal ID “01bd” of the terminal 10bd as the transmission destination. Along with this, the transmitter/receiver 51 of the controller 50a transmits the relaying apparatus connection information for connecting to the selected relaying apparatus 30a to the terminal 10bd via the controller 50b. The relaying apparatus connection information includes the relaying apparatus ID “111a” of the relaying apparatus 30a and the password “xxxx” for connecting to the relaying apparatus 30a.

The transmitter/receiver 11 of the terminal 10bd receives the start request information, thereby accepting the request to start communication from the terminal 10aa. Upon receiving the start request information, the transmitter/receiver 11 of the terminal 10bd transmits call information “Ring” that indicates acceptance of the request to start communication and is for sounding a dial tone at the terminal 10aa to the controller 50b (Step S55-1). The call information includes the terminal ID “01bd” of the terminal 10bd as the transmission source of the call information, the terminal ID “01aa” of the terminal 10aa as the transmission destination, and the session ID “se01@jp.00.com.”

The call information transmitted at Step S55-1 is received by the transmitter/receiver 51 of the controller 50b. This causes the transmitter/receiver 51 of the controller 50b to accept a request to sound a dial tone at the terminal 10aa.

The first changing unit 53a of the state management unit 53 of the controller 50b changes the state information of the terminal 10aa managed by the terminal management table (refer to FIG. 15B) into “Calling” and changes the state information of the terminal 10bd into “Ringing” based on the call information “Ring” transmitted from the terminal 10bd (Step S55-2). The procedure to change the pieces of state information of the terminals (10aa, 10bd) is similar to the processes at Step S51, and the detailed description thereof is omitted.

In a similar manner to Step S53, the session management unit 57 searches the relaying apparatus management table (FIGS. 8A and 8B) with the relaying apparatus ID “111a” of the selected relaying apparatus 30a as a key, thereby extracting the corresponding password “xxxx” (Step S55-3).

The transmitter/receiver 51 of the controller 50b transmits the call information “Ring” transmitted from the terminal 10bd at Step S55-1 via the controller 50a to the terminal 10aa (Steps S55-4, S55-5). The terminal ID of the terminal 10aa as the transmission destination of the start request information includes the domain information “jp1.oo.com,” and the transmitter/receiver 51 can transmit the call information via the controller 50a based on this domain information. This call information includes the terminal ID “01bd” of the terminal 10bd as the transmission source of the call information, the terminal ID “01aa” of the terminal 10aa as the transmission destination, and the session ID. Along with this, the transmitter/receiver 51 of the controller 50b transmits the relaying apparatus connection information for connecting to the relaying apparatus 30a to the terminal 10aa. The relaying apparatus connection information includes the relaying apparatus ID “111a” of the relaying apparatus 30a and the password “xxxx” for connecting to the relaying apparatus 30a.

The transmitter/receiver 11 of the terminal 10aa receives the above call information, thereby accepting a request to sound a ring tone at the terminal 10aa. This enables the voice output unit 15b of the terminal 10aa to sound a dial tone from the speaker 115.

In the terminal 10bd, the voice output unit 15b sounds a ring tone from the speaker 115. This enables the user of the terminal 10bd to know the request to start communication from the terminal 10aa. At the same time, the operation button 108 of the terminal 10bd accepts permission to start communication with the terminal 10aa (Step S56). Upon acceptance of the permission to start communication, start permission information “Accept” indicating permission to start communication is transmitted to the controller 50b (Step S57). This start permission information includes the terminal ID “01bd” of the terminal 10bd as the transmission source of the start permission information, the terminal ID “01aa” of the terminal 10aa as the transmission destination, and the session ID “se01@jp.00.com.” This causes the transmitter/receiver 51 of the controller 50b to accept a response to the permission to start by the terminal 10bd.

The first changing unit 53a of the state management unit 53 of the controller 50b changes the state information of the terminal 10aa and the state information of the terminal 10bd managed by the terminal management table (refer to FIG. 15B) into “Accepted” based on the start permission information “Accept” transmitted from the terminal 10bd (Step S58). The procedure to change the pieces of state information of the terminals 10 is similar to the processes at Step S51, and the detailed description thereof is omitted.

The controller 50b then transmits the start permission information “Accept” transmitted from the terminal 10bd at Step S57-1 to the terminal 10aa via the controller 50a (Steps S59-1, S59-2). The terminal ID of the terminal 10aa as the transmission destination of the start permission information includes the domain information “jp1.oo.com,” and the transmitter/receiver 51 can transmit the start permission information via the controller 50a based on this domain information. This start permission information includes the terminal ID “01bd” of the terminal 10bd as the transmission source of the start permission information, the terminal ID “01aa” of the terminal 10aa as the transmission destination, and the session ID.

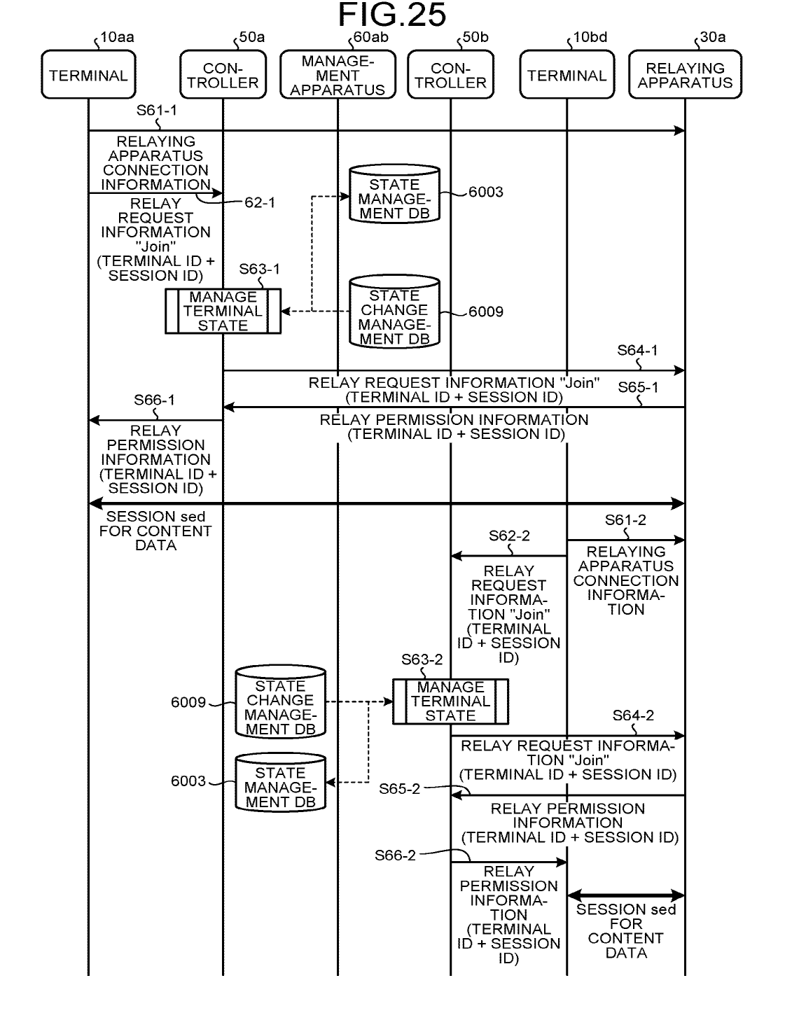

The following describes operation to start the session sed for content data between the terminals (10aa, 10bd) after the request to start communication is permitted with reference to FIG. 25. FIG. 25 is a sequence diagram illustrating procedure to start communication between the terminals 10. In the communication between the terminal 10 and the controller 50 in FIG. 25, various management information is transmitted and received by the session sei for management information illustrated in FIG. 2.

First, the terminal 10aa connects to the relaying apparatus 30a based on the relaying apparatus connection information received at Step S55-5 (Step S61-1). The transmitter/receiver 11 of the terminal 10aa then transmits relay request information “Join” indicating a request to start relaying to the controller 50a (Step S62-1). This relay request information includes the terminal ID “01aa” of the terminal 10aa and the session ID “se01@jp.00.com.” This causes the transmitter/receiver 51 of the controller 50a to accept the request to start relaying by the terminal 10aa.

The first changing unit 53a of the state management unit 53 of the controller 50a changes the state information of the terminal 10aa managed by the state management table (FIG. 10A) into “Busy” based on the relay request information “Join” transmitted from the terminal 10aa (Step S63-1). The procedure to change the state information of the terminal 10 is similar to the processes at Step S51, and the detailed description thereof is omitted.

The transmitter/receiver 51 of the controller 50a transmits the relay request information including the terminal ID “01aa” of the terminal 10aa and the session ID “se01” to the relaying apparatus 30a (Step S64-1). Upon acceptance of this relay request information, the transmitter/receiver 31 of the relaying apparatus 30a transmits relay permission information that includes the terminal ID “01aa” of the terminal 10aa and the session ID “se01” and indicates permission to start relaying to the controller 50a (Step S65-1). The transmitter/receiver 51 of the controller 50a transmits the received relay permission information to the terminal 10aa (Step S66-1). This establishes the session sed for content data between the terminal 10aa and the relaying apparatus 30a.

The terminal 10bd connects to the relaying apparatus 30a based on the relaying apparatus connection information received at Step S56 (Step S61-2). The transmitter/receiver 11 of the terminal 10bd then transmits the relay request information “Join” indicating a request to start relaying to the controller 50b (Step S62-2). This relay request information includes the terminal ID “01bd” of the terminal 10bd and the session ID “se01@jp.00.com.” This causes the transmitter/receiver 51 of the controller 50b to accept the request to start relaying by the terminal 10bd.

The first changing unit 53a of the state management unit 53 of the controller 50b changes the state information of the terminal 10bd managed by the state management table (FIG. 10A) into “Busy” based on the relay request information “Join” transmitted from the terminal 10bd (Step S63-2). The procedure to change the state information of the terminal 10 is similar to the process at Step S51, and the detailed description thereof is omitted.

The transmitter/receiver 51 of the controller 50b then transmits the relay request information including the terminal ID “01bd” of the terminal 10bd and the session ID “se01” to the relaying apparatus 30a (Step S64-2). Upon acceptance of this relay request information, the relaying apparatus 30a transmits relay permission information that includes the terminal ID “01bd” of the terminal 10bd and the session ID “se01” and indicates permission to start relaying to the controller 50b (Step S65-2). The transmitter/receiver 51 of the controller 50b transmits the received relay permission information to the terminal 10bd (Step S66-2). This establishes the session sed for content data between the terminal 10bd and the relaying apparatus 30a. Upon establishment of the respective sessions sed for content data, the relaying apparatus 30a relays the content data including image data and voice data transmitted from one of the terminals (10aa, 10bd) to the other, thereby starting a teleconference.

Participation

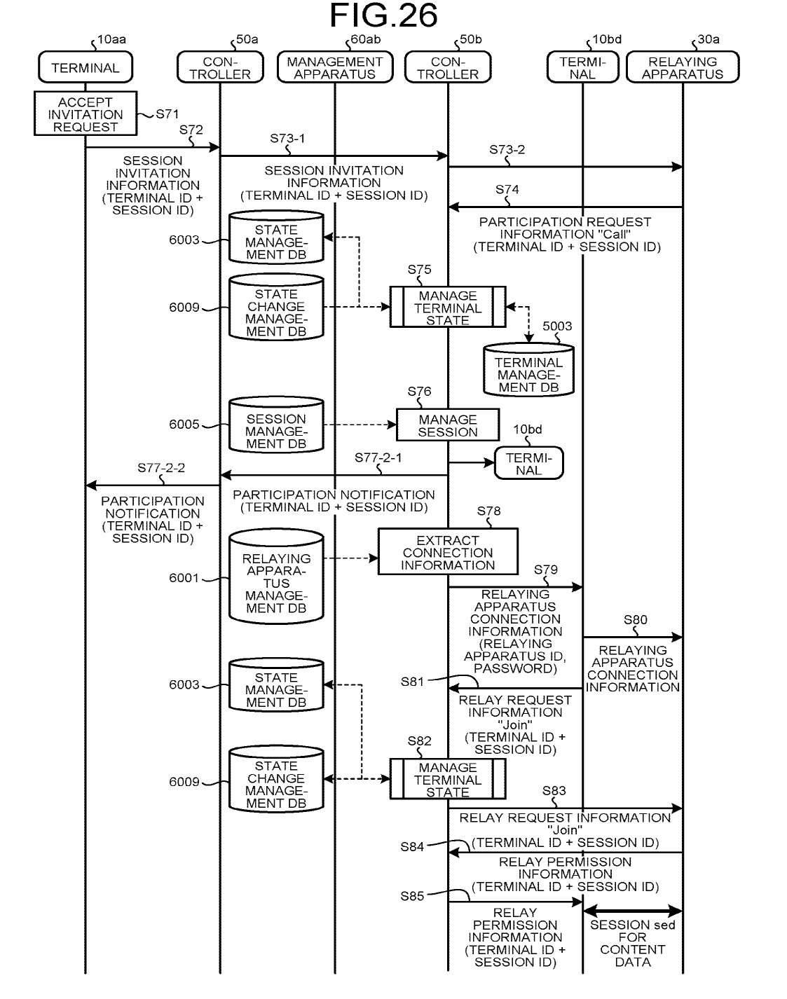

The following describes operation to start communication among three terminals 10 through the participation of the terminal 10bb in the session sed for content data after the session sed for content data has been established between the terminal 10aa and the terminal 10bd with reference to FIG. 26. FIG. 26 is a sequence diagram illustrating procedure to start communication among the three terminals. In the communication between the terminal 10 and the controller 50 in FIG. 26, various management information is transmitted and received by the session sei for management information.

First, the user of the terminal 10aa that is performing communication with the terminal 10bd presses down the operation button 108 illustrated in FIG. 3, thereby causing the operation input accepting unit 12 to accept a request to invite the terminal 10bb to the session in communication (Step S71). Next, the transmitter/receiver 11 of the terminal 10aa transmits session invitation information that includes the terminal ID “01aa” of the terminal 10aa, the terminal ID “01bb” of the terminal 10bb, and the session ID “se01” and indicates invitation to the session in communication to the controller 50a (Step S72). The session ID may be identification such as conference ID, communication ID, and call ID identifying events such as a conference, communication, a call corresponding to the session sed for content data. The transmitter/receiver 51 of the controller 50a transmits the received session invitation information to the terminal 10bb via the controller 50b (Steps S73-1, S73-2). The terminal ID of the terminal 10bb as the transmission destination of the session invitation information includes the domain information “jp2.oo.com,” and the transmitter/receiver 51 can transmit the session invitation information via the controller 50b based on this domain information.

In response to this invitation, the transmitter/receiver 11 of the terminal 10bb transmits participation request information “Call” indicating a request to participate in this session to the controller 50b (Step S74). This participation request information includes the terminal ID “01bb” of the terminal 10bb that requests to participate in this session and the session ID “se01@jp.00.com.” This causes the transmitter/receiver 51 of the controller 50b to accept the request to participate in the session sed for content data from the terminal 10bb.

The first changing unit 53a of the state management unit 53 of the controller 50b changes the state information of the terminal 10bb managed by the terminal management table (FIG. 15B) into “Accepted” based on the participation request information “Call” transmitted from the terminal 10bb (Step S75). The procedure to change the state information of the terminal 10 is similar to the processes at Step S51, and the detailed description thereof is omitted.

After the state information of the terminal 10bb is changed by the first changing unit 53a of the controller 50a, the first changing unit 53a changes the operation state of the terminal 10bb managed by the terminal management table (refer to FIG. 16) from “Online” into “Online (in conference).” The operation state of the terminal bb in the controller 50b is made coincide with the changed operation state of the terminal bb in the controller 50a according to the processes at Step S31b to Step S34b.

The session management unit 57 of the controller 50b adds the terminal ID “01bb” of the terminal 10bb that requests participation in a destination terminal field of a record including the session ID “se01” in the session management table (refer to FIGS. 12A and 12B) (Step S76). In this case, the session management unit 57 of the controller 50b transmits the above session ID and terminal ID to the management apparatus 60ab via the transmitter/receiver 51, thereby requesting to record these pieces of information in the session management table. The storage/reading processing unit 69 of the management apparatus 60ab records the terminal ID “01bb” in the session management table in association with the destination terminal field of the record including the session ID “se01”.

The transmitter/receiver 51 of the controller 50b transmits participation notification including the terminal ID “01bb” of the terminal 10bb participating in the session sed for content data and the session ID “se01” to the terminal 10aa and the terminal 10bd that are performing communication in this session (Steps S77-1, S77-2-1, S77-2-2). This enables the terminal 10aa and the terminal 10bd to grasp the participation of the terminal 10bb in the session sed for content data.

The session management unit 57 searches the relaying apparatus management table (FIGS. 8A and 8B) with the relaying apparatus ID “111a” of the selected relaying apparatus 30a as a key, thereby extracting the corresponding password “xxxx” (Step S78). In this case, the session management unit 57 of the controller 50b transmits the above session ID and relaying apparatus ID to the management apparatus 60ab via the transmitter/receiver 51, thereby requesting to provide notification of the corresponding password for connecting to the relaying apparatus 30a. The extracting unit 64 of the management apparatus 60ab extracts the password corresponding to the relaying apparatus ID from the relaying apparatus management table. The extracted password is transmitted to the controller 50b by the transmitter/receiver 61.

The transmitter/receiver 51 of the controller 50b transmits the relaying apparatus connection information for connecting to the relaying apparatus 30a that relays the content data in this session to the terminal 10bb. The relaying apparatus connection information includes the relaying apparatus ID “111a” of the relaying apparatus 30a and the password “xxxx” for connecting to the relaying apparatus 30a managed by the relaying apparatus management table (refer to FIG. 8A) (Step S79).

Then, by performing the procedure similar to the processes at Steps S61-2 to S66-2, the session sed for content data between the terminal 10bb and the relaying apparatus 30a is established (Steps S80 to S85). Upon establishment of this session, the relaying apparatus 30a can relay the content data among the terminals (10aa, 10bb, 10bd). This enables the terminals (10aa, 10bb, 10bd) to start a teleconference.

End

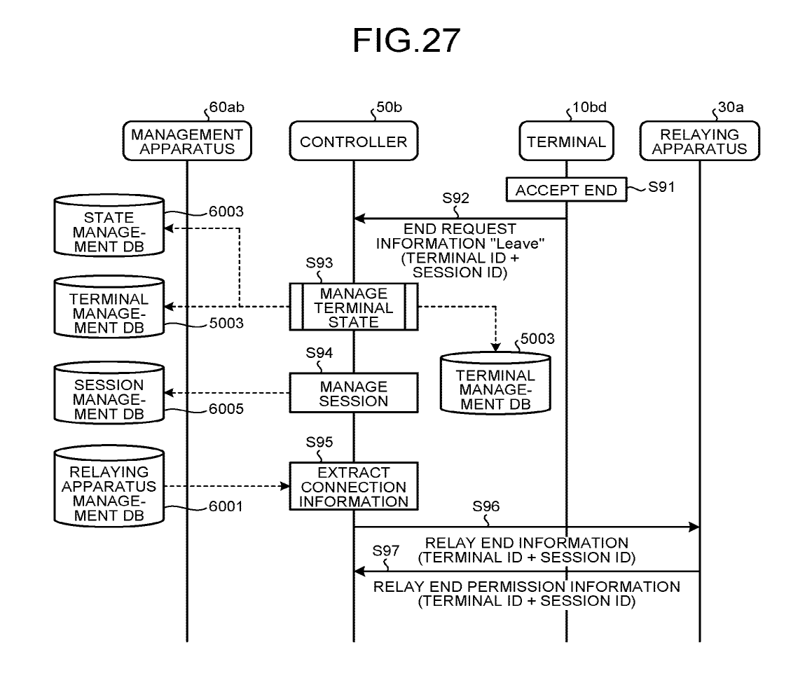

The following describes operation in which, after the session sed for content data has been established among the terminals (10aa, 10bb, 10bd), the terminal 10bd leaves the session sed for content data to end communication with reference to FIG. 27. FIG. 27 is sequence diagram illustrating procedure to end communication. FIG. 27 illustrates procedure to transmit and receive various management information by the session sei for management information.

First, the user of the terminal 10bd presses down the operation button 108 illustrated in FIG. 4, thereby accepting a request to end communication (Step S91). The transmitter/receiver 11 of the terminal 10bd transmits end request information “Leave” including the terminal ID “01bd” of the terminal 10bd and the session ID “se01@jp.00.com” identifying the session sed for content data used in this communication to the controller 50b (Step S92). This causes the transmitter/receiver 51 of the controller 50b to accept the request to end communication from the terminal 10bd.

The first changing unit of the state management unit 53 of the controller 50b changes the state information of the terminal 10bd managed by the terminal management table (FIG. 15B) into “None” based on the participation request information “Leave” transmitted from the terminal 10bd (Step S93). The procedure to change the state information of the terminal 10 is similar to the process at Step S51, and the detailed description thereof is omitted.

After the state information of the terminal 10bd is changed by the first changing unit 53a of the controller 50b, the first changing unit 53a changes the operation state of the terminal 10bd managed by the terminal management table from “Online (in conference)” into “Online.” The operation state of the terminal 10bd in the controller 50a is made coincide with the changed operation state of the terminal 10bd in the controller 50b according to the processes at Step S31b to Step S34b.

The session management unit 57 deletes the terminal ID “01bd” of the terminal 10bd from the terminal ID field of the record including the session ID “se01” in the session management table (refer to FIGS. 12A and 12B) (Step S94). In this case, the session management unit 57 of the controller 50b transmits the above session ID and terminal ID to the management apparatus 60ab via the transmitter/receiver 51, thereby requesting to delete the terminal ID managed by the session management table. The storage/reading processing unit 69 of the management apparatus 60ab deletes the terminal ID “01bd” from the destination terminal field of the record including the session ID “se01” in the session management table.

The session management unit 57 searches the relaying apparatus management table (FIGS. 8A and 8B) with the relaying apparatus ID “111a” of the selected relaying apparatus 30a as a key, thereby extracting the corresponding password “xxxx” (Step S95). In this case, the session management unit 57 of the controller 50b transmits the above session ID and relaying apparatus ID to the management apparatus 60ab via the transmitter/receiver 51, thereby providing notification of the corresponding password. The extracting unit 64 of the management apparatus 60ab extracts the password corresponding to the relaying apparatus ID from the relaying apparatus management table, and the transmitter/receiver 61 transmits the extracted password to the controller 50b.

The transmitter/receiver 51 transmits relay end information to end relaying including the terminal ID “01bd” of the terminal 10bd and the session ID “se01” to the relaying apparatus 30a (Step S96). The relaying apparatus 30a then transmits relay end permission information that includes the terminal ID “01bd” and the session ID “se01” and permits to end relaying to the controller 50b (Step S97). This causes the relaying apparatus 30a to stop the relay of the content data transmitted from the terminal 10bd to the terminals (10aa, 10bb) and the relay of the content data transmitted from the terminals (10aa, 10bb) to the terminal 10bd (Step S96). This causes the terminal 10bd to end the communication with the terminals (10aa, 10bd) and to leave the session sed for content data.

Supplemental

The controller 50, the management apparatus 60, the selecting apparatus 80, and the program providing system 90 of the above embodiment may be constructed by a single computer and may be constructed by a plurality of computers to which divided components (functions or means) are arbitrarily assigned. When the program providing system 90 is constructed by a single computer, the program to be transmitted by the program providing system 90 may be transmitted after being divided into a plurality of modules and may be transmitted without being divided. When the program providing system 90 is constructed by a plurality of computers, a plurality of modules may be transmitted from the respective computers in a divided manner.

Recording media storing therein the program for a selecting apparatus, the program for terminals, the program for relaying apparatuses, and the program for communication management, the HD 204 storing therein these programs, and the program providing system 90 including the HD 204 are all used when they are provided to domestic or overseas users or the like of the above program for terminals, program for relaying apparatuses, and program for communication management as program products.

The above embodiment may manage the fully qualified domain names (FQDN) of the respective pieces of domain information. In this case, IP addresses corresponding to the FQDNs are acquired by a known domain name system (DNS) server. The ID such as the terminal ID and the relaying apparatus ID may be denoted as, for example, “relaying apparatus connection destination information indicating the connection destination to the relaying apparatus 30 on the communication network 2,” “relaying apparatus destination information indicating the destination to the relaying apparatus 30 on the communication network 2,” “terminal connection destination information indicating the connection destination to the terminal 10 on the communication network 2,” or “terminal destination information indicating the destination to the terminal 10 on the communication network 2.”

In the present embodiment, the “teleconference” is used as a term replaceable with a “videoconference.” Although the above embodiment describes the teleconference system as an example of the communication system 1, it is not limiting and may be a telephone system such as Internet Protocol (IP) telephone and Internet telephone. The communication system 1 may be a car navigation system. In this case, for example, one terminal 10 corresponds to a car navigation apparatus installed in a car, whereas another terminal 10 corresponds to a management terminal or a management server of a management center managing the car navigation or a car navigation apparatus installed in another car. The communication system 1 may also be a voice conference system or a personal computer (PC) screen sharing system.

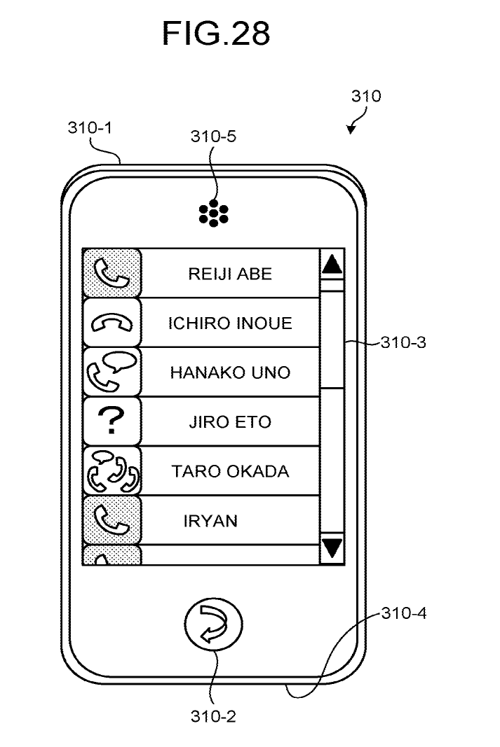

The communication system 1 may be a communication system of mobile phones. In this case, the terminal corresponds to a mobile phone, for example. A display example of a destination list for this case is illustrated in FIG. 28. FIG. 28 is a conceptual diagram illustrating a destination list of another embodiment. Specifically, a terminal 310 as a mobile phone includes a main body 310-1 of the mobile phone, a menu screen display button 310-2 arranged on the main body 310-1, a display unit 310-3 arranged on the main body 310-1, a microphone 310-4 arranged on the lower part of the main body 310-1, and a speaker 310-5 arranged on the main body 310-1. Among these, the “menu screen display button” 310-2 is a button for displaying a menu screen displaying icons indicating various applications. The display unit 310-3 is formed as a touch panel and can perform communication with another mobile phone through the selection of a destination name by a user.

Although the above embodiment describes a case of performing a teleconference by the communication system 1, it is not limiting and may be used in meetings, general conversations such as ones between members of a family or friends, or unidirectional information provision.

As described above, using the connection management apparatus according to the present invention can perform control that is related to sessions and includes connection to the relaying apparatus in a distributed manner by a plurality of controllers, thereby producing the effect of reducing a load imposed on each controller.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A connection management apparatus, comprising:
a connection information management unit that, when a session for transmitting content data between communication terminals via a relaying apparatus is established based on control by a first controller, manages relaying apparatus connection information used for connecting to the relaying apparatus that relays the content data transmitted between the communication terminals in the session; and
a transmitter that, when control that is related to the session and includes connection to the relaying apparatus is performed by a second controller different from the first controller, transmits the relaying apparatus connection information managed by the connection information management unit to the second controller.

2. The connection management apparatus according to claim 1, wherein the control that includes connection to the relaying apparatus is control for disconnecting the session or control for causing a new communication terminal to participate in the session.

3. A communication management system, comprising:
the connection management apparatus according to claim 1;
the first controller; and
the second controller.

4. The communication management system according to claim 3, wherein the first controller comprises a transmitter that transmits the relaying apparatus connection information used for connecting to the relaying apparatus that relays the content data in the session to the connection management apparatus.

5. The communication management system according to claim 3, wherein the second controller comprises a connection information receiver that receives the relaying apparatus connection information transmitted from the connection management apparatus, and performs the control that is related to the session and includes connection to the relaying apparatus based on the relaying apparatus connection information received by the connection information receiver.

6. The communication management system according to claim 3, wherein
the connection management apparatus comprises a state management unit that is provided for each of the communication terminals and manages state information indicating a state of communication, and
each of the controllers comprises:
a first changing unit that, when the controller performs the control related to the session, changes state information indicating the state of the communication in a communication terminal related to the session among the pieces of state information managed by the state management unit into state information indicating the state of the communication after being changed by the control;
a receiver that, when the other controller performs control related to the session, receives changed state information indicating the state of the communication of the communication terminal related to the session after being changed by the control from the other controller; and
a second changing unit that changes state information indicating the state of the communication in the communication terminal related to the session among the pieces of state information managed by the state management unit based on the changed state information.

7. The communication management system according to claim 3, wherein the first controller and the second controller are located within the same domain.

8. The communication management system according to claim 7, wherein each of the controllers comprise an identifying unit that identifies the other controller located within the same domain.

9. A communication system, comprising:
the communication management system according to claim 3;
a first communication terminal that connects to the first controller;
a second communication terminal that connects to the second controller; and
a relaying apparatus that relays the content data transmitted between the first communication terminal and the second communication terminal.

10. A computer program product comprising a computer-readable medium including a computer program that causes a connection management apparatus that, when a session for transmitting content data between communication terminals via a relaying apparatus is established based on control by a first controller, manages relaying apparatus connection information used for connecting to the relaying apparatus that relays the content data transmitted between the communication terminals in the session, the computer program causing the connection management to execute:
transmitting, when control that is related to the session and includes connection to the relaying apparatus is performed by a second controller different from the first controller, the relaying apparatus connection information managed by the connection information management unit to the second controller;
causing the second controller to receive the relaying apparatus connection information; and
causing the second controller to perform the control that is related to the session and includes connection to the relaying apparatus based on the relaying apparatus connection information.

11. A method for controlling connection performed by a connection management apparatus that, when a session for transmitting content data between communication terminals via a relaying apparatus is established based on control by a first controller, manages relaying apparatus connection information used for connecting to the relaying apparatus that relays the content data transmitted between the communication terminals in the session,
the method comprising:
transmitting, when control that is related to the session and includes connection to the relaying apparatus is performed by a second controller different from the first controller, the relaying apparatus connection information managed by the connection information management unit to the second controller;
causing the second controller to receive the relaying apparatus connection information; and
causing the second controller to perform the control that is related to the session and includes connection to the relaying apparatus based on the relaying apparatus connection information.
